(19) United States
(12) Patent Application Publication
(10) Pub. No.: US 2006/0262211 A1
(43) Pub. Date: Nov. 23, 2006

(54) Image sensing apparatus

(75) Inventor: Toshihito Kido, Matsubara-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/245,638

(22) Filed: Oct. 7, 2005

(30) Foreign Application Priority Data
May 18, 2005 (JP) 2005-145003

(51) Int. Cl. H04N 5/335

(52) U.S. Cl. 348/308

(57) ABSTRACT

An image sensing apparatus is provided with a CMOS image sensor including a number of pixels arrayed in a first direction and a second direction orthogonal to each other, a luminance distribution detecting section which detects a luminance distribution of an optical image of a subject incidented to the image sensor; and an image processing section which corrects an output value of the pixel to a predetermined value based on a luminance distribution of a predetermined high luminance region in the luminance distribution detected by the luminance distribution detecting section.

This application is based on Japanese Patent Application No. 2005-145003 filed on May 18, 2005, the contents of which are hereby incorporated by reference.

### BACKGROUND OF THE INVENTION

1. Field of the Invention

The present invention relates to an image sensing apparatus loaded with a CMOS image sensor.

2. Description of the Related Art

As compared with a charge-coupled device (CCD) image sensor, a complementary metal oxide semiconductor (CMOS) image sensor is superior in readout speed performance of pixel signals, power saving performance, and large-scale integration. The CMOS image sensor is one of preferred image sensors to be loaded in an image sensing apparatus in light of the size of the unage sensor relative to the image sensing apparatus, requirements on the performance of the image sensor, or other factor.

There is a case that an image sensing apparatus loaded with a CMOS image sensor may suffer from a phenomenon that an image area having a high luminance is captured in black. Hereinafter, this phenomenon is called as “inversion”. Japanese Unexamined Patent Publication No. 2004-187017 discloses a technique to solve the above drawback. According to the technique, in a high luminance black crushing circuit comprised of capacitors, switching devices, and operation amplifiers, reset levels or second signals of the respective switching devices are constantly monitored, and a signal indicative of a white level is applied to the switching device whose reset level is over a reference signal level by a predetermined value.

In the publication, since the high luminance black crushing circuit is constituted of the capacitors, the switching devices, and the operation amplifiers to constantly monitor the reset levels or the second signals of the respective switching devices, the construction of the image sensor is complicated, which may raise the production cost of an image sensing apparatus incorporated with the image sensor.

### SUMMARY OF THE INVENTION

It is an object of the present invention to provide an image sensing apparatus which is free from the problems residing in the prior art.

It is another object of the present invention to provide an image sensing apparatus which can prevent or suppress occurrence of inversion with a simplified arrangement.

According to an aspect of the invention, an image sensing apparatus is provided with a CMOS image sensor including a number of pixels, a luminance distribution detector for detecting a luminance distribution of an optical image of a subject incidented to the image sensor, and an image processor for correcting an output value of the pixel to a predetermined value based on a luminance distribution of a predetermined high luminance region in the luminance distribution detected by the luminance distribution detector.

These and other objects, features and advantages of the present invention will become more apparent upon reading of the following detailed description along with the accompanying drawings.

### BRIEF DESCRIPTION OF THE DRAWINGS

FIG. 1 is a front view of an image sensing apparatus according to a first embodiment of the invention.

FIG. 2 is a rear view of the image sensing apparatus.

FIG. 3 is an illustration showing an internal arrangement of the image sensing apparatus.

FIG. 4 is a block diagram showing an electrical configuration of the entirety of the image sensing apparatus in a state that a lens unit is attached to an apparatus body.

FIG. 5 is a diagram showing a schematic arrangement of an image sensor to be incorporated in the image sensing apparatus.

FIG. 6A is an illustration showing an image capturing area of the image sensor.

FIG. 6B is an illustration showing a light metering area of a light metering sensor.

FIG. 6C is an illustration showing a corresponding relation between the image capturing area of the image sensor and the light metering area of the light metering sensor.

FIGS. 7A through 7C are timing charts for explaining operations of a pixel in the image sensor.

FIG. 8 is an illustration explaining a judgment as to occurrence of inversion by a data corrector.

FIGS. 9A through 9C are illustrations explaining the judgment as to occurrence of inversion by the data corrector.

FIG. 10 is an illustration explaining a manner as to how a threshold value for pixel data is set to perform pixel data replacement.

FIG. 11 is a flowchart showing a correction processing to be implemented by the image sensing apparatus.

FIG. 12 is an illustration showing a relation between a subject luminance and an output from the light metering sensor in correspondence to the subject luminance.

FIG. 13 is a front view of an image sensing apparatus according to a second embodiment of the invention.

FIG. 14 is a rear view of the image sensing apparatus of the second embodiment.

FIG. 15 is a diagram showing an electrical configuration of the image sensing apparatus of the second embodiment.

FIG. 16 is an illustration showing how a pixel for a live-view image generation, and a pixel for judging inversion are set in the pixels arrayed in a matrix.

FIGS. 17A through 17C are timing charts showing an exposure operation of a live-view image generation pixel S, and an output operation of a pixel signal from the live-view image generation pixel S in the case where one frame of a live-view image is generated in a process of cyclically generating the live-view image.

FIGS. 17D through 17F are timing charts showing an exposure operation of an inversion judging pixel T, and an output operation of a pixel signal from the inversion judging pixel T in association with the exposure operation of the pixel S and the output operation of the pixel signal from the pixel S.

FIG. 18A is an illustration showing all the live-view image generation pixels, and all the inversion judging pixels in proximity to the live-view image generation pixels in the pixels of the image sensor shown in FIG. 16.

FIG. 18B is an illustration showing an order of outputting pixel signals from the pixels shown in FIG. 18A.

FIG. 19 is a flowchart showing a correction processing to be implemented by the image sensing apparatus of the second embodiment.

FIG. 20 is an illustration explaining a first modified correction processing.

FIG. 21 is an illustration explaining a second modified correction processing.

### DETAILED DESCRIPTION OF THE PREFERRED EMBODIMENTS OF THE INVENTION

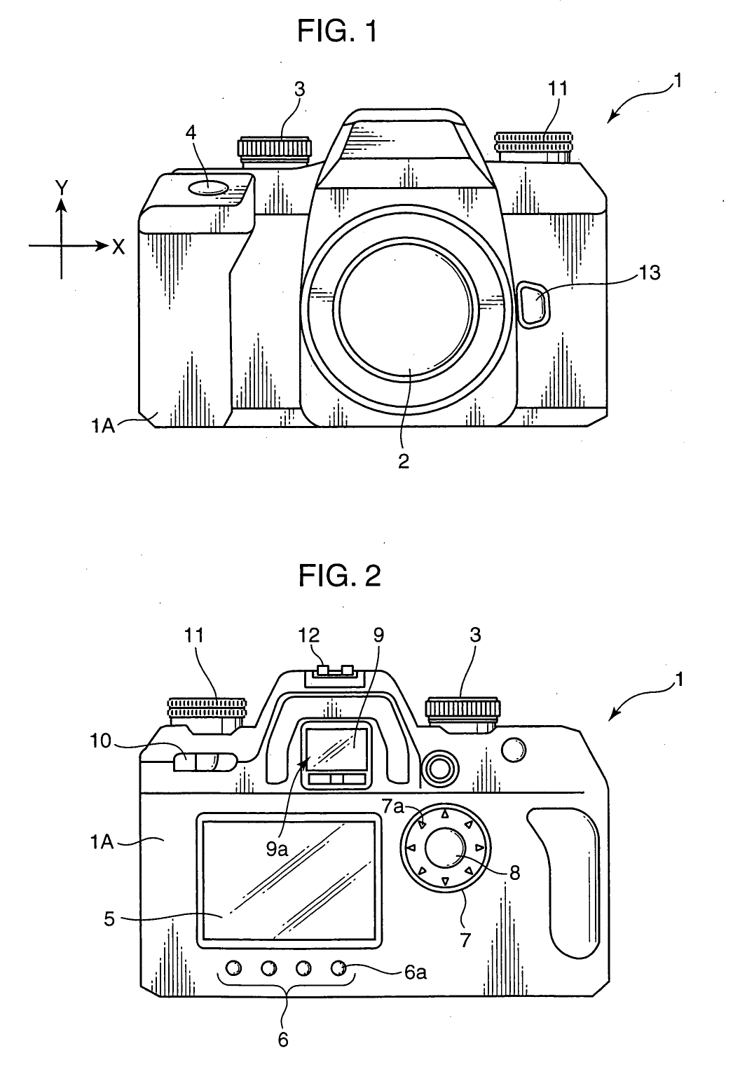

An image sensing apparatus embodying the invention will be described with reference to drawings. Elements identical to each other in the drawings are denoted at the same reference numerals. Referring to FIGS. 1 to 3 showing an image sensing apparatus in the first embodiment of the invention, the image sensing apparatus 1 is a single lens reflex image sensing apparatus having a lens unit 2 exchangeably or detachably attached to a box-shaped apparatus body 1A.

The image sensing apparatus 1 comprises the lens unit 2 which is attached to a substantially middle part to a front face of the apparatus body 1A, a first mode setting dial 3 which is arranged at an appropriate position on an upper face of the apparatus body 1A, a shutter button 4 which is arranged at a corner portion on the upper face of the apparatus body 1A, a liquid crystal display (LCD) 5 which is arranged on a left side of a rear face of the apparatus body 1A in FIG. 2, a setting button group 6 which is arranged on a lower part relative to the LCD 5, a jog dial 7 which is arranged on a side of the LCD 5, a push button 8 which is arranged at a radially inner position of the jog dial 7, an optical viewfinder 9 which is arranged at an upper part relative to the LCD 5, a main switch 10 which is arranged on a side of the optical viewfinder 9, a second mode setting dial 11 which is arranged in the vicinity of the main switch 10, and a connecting terminal portion 12 which is arranged on the top part of the apparatus body 1A above the optical viewfinder 9.

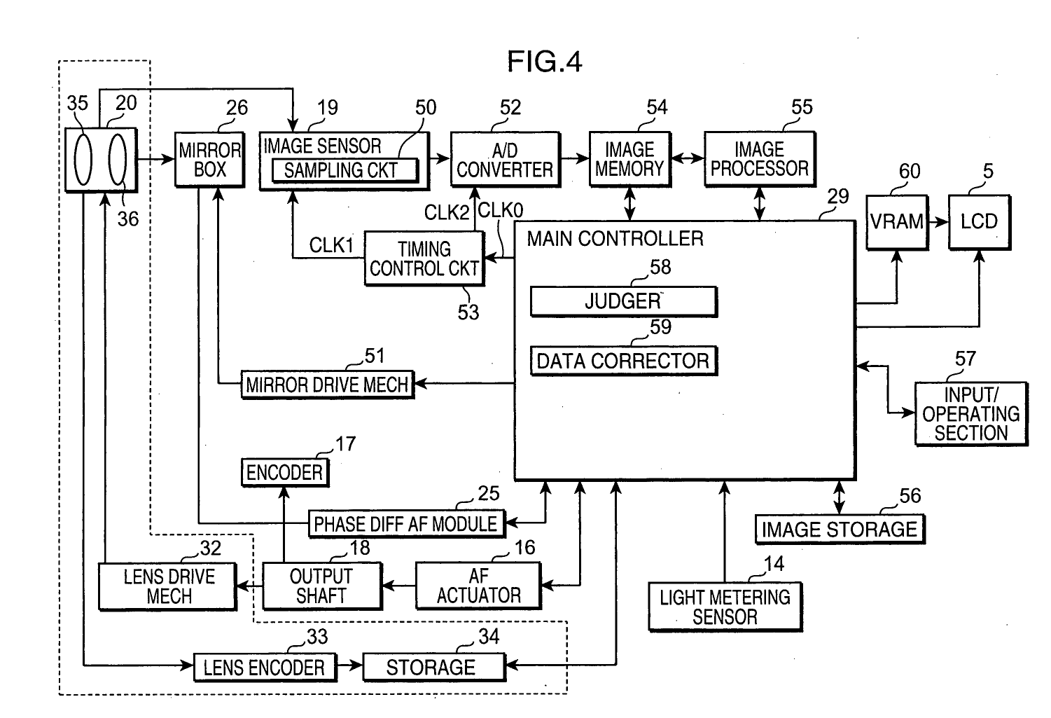

The lens unit 2 is constructed in such a manner that lens elements serving as optical devices are arrayed inside a lens barrel in a direction perpendicular to the plane of FIG. 1. The lens unit 2 incorporates therein a zoom lens element 35 (see FIG. 4) for zooming, and a focus lens element 36 (see FIG. 4) for focus control, as the optical devices. The zoom lens elements 35 and the focus lens element 36 perform zooming and focus control by being driven in an optical axis direction of the lens unit 2, respectively.

The lens unit 2 includes an unillustrated rotatable operation ring, which is provided at an appropriate position on an outer circumferential portion of the lens barrel along the outer circumference thereof. The zoom lens element 35 is manually movable to an intended position in the optical axis direction in accordance with a rotation direction and an angular displacement of the operation ring to attain a designated zoom ratio corresponding to the intended position. The lens unit 2 is detachable from the apparatus body 1A when a user or a photographer presses a detachment button 13.

The first mode setting dial 3 has a substantially disc-like shape and is made pivotally rotatable on a plane substantially parallel to the upper face of the image sensing apparatus 1. The first mode setting dial 3 is adapted to select one of various modes or functions loaded in the image sensing apparatus 1 such as a mode of shooting a still image, a mode of shooting a moving image, and a mode of playing back a recorded image. Although not illustrated, characters or symbols respectively representing the functions of the image sensing apparatus 1 are marked at a certain interval on the upper face of the first mode setting dial 3 along the outer perimeter thereof, so that the function corresponding to the character or the symbol designated by a pointer provided at an appropriate position on the apparatus body 1A can be executed.

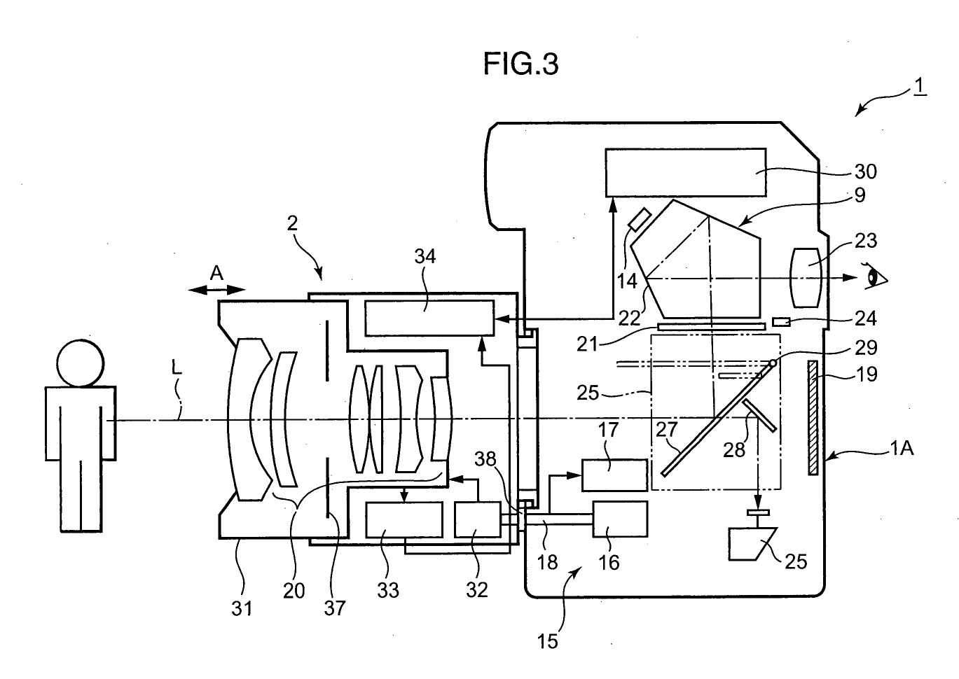

The shutter button 4 is of a depressing type, and is operable in two states, namely, a halfway pressed state and a fully pressed state. The shutter button 4 is adapted to designate a timing of an exposure operation to be implemented by an image sensor 19 (see FIGS. 3 and 4), which will be described later. When the shutter button 4 is pressed halfway down, the image sensing apparatus 1 is brought to an image shooting standby state, wherein setting of an exposure control value such as a shutter speed and an aperture value is conducted with use of a detection signal sent from a light metering sensor (see FIG. 3), which will be described later. When the shutter button 4 is pressed fully down, an exposure operation by the image sensor 19 is initiated to generate an image of a subject to be recorded in an image storage 56 (see FIG. 4), which will be described later. The halfway pressed state of the shutter button 4 is detected in response to turning on of a switch S1 (not shown), and the fully pressed state of the shutter button 4 is detected in response to turning on of a switch S2 (not shown).

The LCD 5 includes a color liquid crystal display panel. The LCD 5 is adapted to display an image captured by the image sensor 19, to display a recorded image for playback, and to display a screen image for setting a function or a mode incorporated in the image sensing apparatus 1. An organic electroluminescent device or a plasma display device may be used in place of the LCD 5. The setting button group 6 is a group of buttons for allowing a user to designate various functions incorporated in the image sensing apparatus 1.

The jog dial 7 includes an annular member provided with plural pressing portions 7a indicated by triangular marks in FIG. 2 which are arrayed at a certain interval in a circumferential direction of the annular member. The jog dial 7 is constructed in such a manner that a contact or a switch (not shown) provided in correspondence to each one of the pressing portions 7a of the jog dial 7 detects whether the corresponding pressing portion has been manipulated. The push button 8 is arranged in the middle of the jog dial 7. With use of the jog dial 7 and the push button 8, the user is allowed to input designation regarding feeding of frames of recorded images to be played back on the LCD 5, setting of photographing conditions such as the aperture value, the shutter speed, firing/non-firing of flash, and the like.

The optical viewfinder 9 is adapted to optically display an image capturing area within which a subject image is captured. The main switch 10 is a slide switch of 2-contact, which slides in sideways directions of the image sensing apparatus 1. When the main switch 10 is slid leftward, the main power of the image sensing apparatus 1 is turned on, and when the main switch 10 is slid rightward, the main power of the image sensing apparatus 1 is turned off.

The second mode setting dial 11 has a mechanical construction similar to that of the first mode setting dial 3. With the second mode setting dial 11, the user is allowed to manipulate the various functions incorporated in the image sensing apparatus 1. The connecting terminal portion 12 is a terminal for connecting the image sensing apparatus 1 to an external device such as an unillustrated flash device.

As shown in FIG. 3, the apparatus body 1A is incorporated with an AF driving unit 15, the image sensor 19, the optical viewfinder 9, a phase difference AF module 25, a mirror box 26, the light metering sensor 14, and a main controller 30.

The AF driving unit 15 includes an AF actuator 16, an encoder 17, and an output shaft 18. The AF actuator 16 has various motors such as a DC motor for generating a drive source, a stepping motor, and an ultrasonic motor, and an unillustrated speed reduction system for reducing the rotation number of each motor.

Briefly describing the encoder 17, the encoder 17 is adapted to detect a rotated amount of a motor which is transmitted from the AF actuator 16 to the output shaft 18. The detected rotated amount of the motor is used in calculating the position of a photographic optical system 20 in the lens unit 2. The output shaft 18 transmits a driving force of the motor outputted from the AF actuator 16 to a lens driving mechanism 32 provided in the lens unit 2, which will be described later.

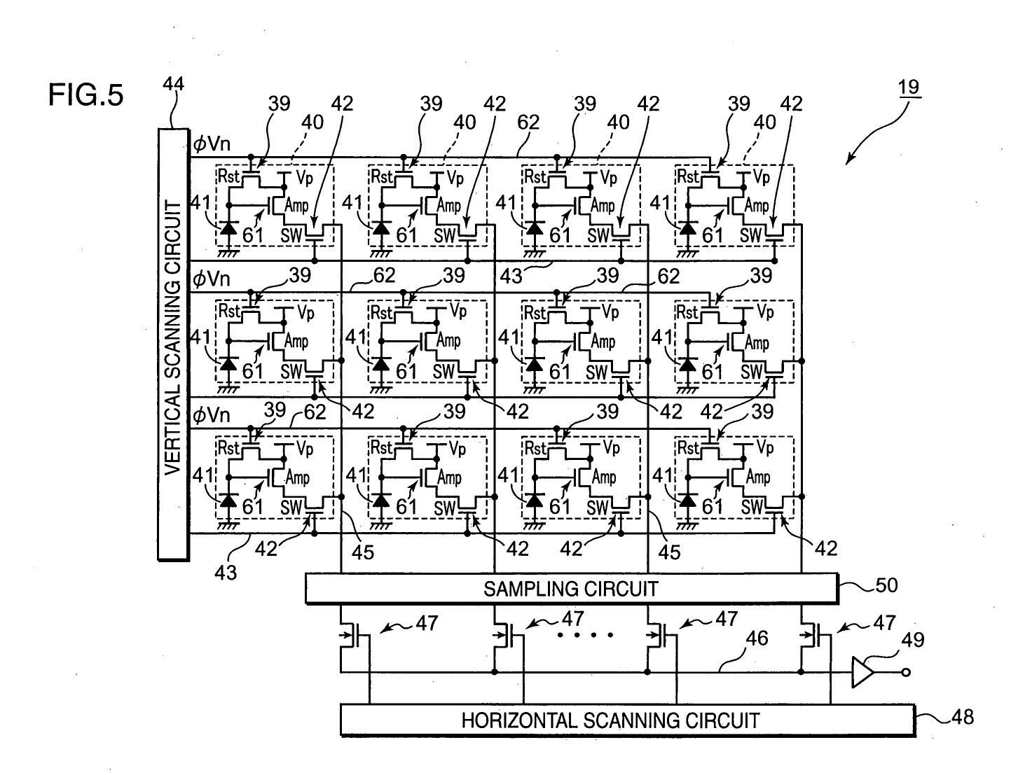

The image sensor 19 is arranged in a portion on the rear side of the apparatus body 1A substantially in parallel with the rear face thereof. As will be described later in detail, the image sensor 19 is, for instance, a complementary metal oxide semiconductor (CMOS) color area sensor of a so-called “Bayer matrix” in which pixels 40 (see FIG. 5) each constituted of a photodiode 41 (see FIG. 5) are arrayed two-dimensionally in a matrix, and patches of color filters in red (R), green (G), and blue (B) having different spectral characteristics from each other are attached on light receiving surfaces of the respective pixels 40 with a ratio of 1:2:1. The image sensor 19 converts an optical image of a subject formed by the photographic optical system 20 into analog electrical signals, namely, image signals of respective color components of R, G, and B for outputting.

The optical viewfinder 9 is arranged above the mirror box 26 which is disposed substantially in the middle of the apparatus body 1A. The optical viewfinder 9 has a focusing glass 21, a prism 22, an eyepiece element 23, and a viewfinder display device 24. The prism 22 laterally reverses an image of the subject formed on the focusing glass 21, and guides the laterally-reversed subject image to the eye of the photographer via the eyepiece element 23, so that the photographer can visually recognize the subject image. The viewfinder display device 24 is adapted to display various parameters such as a shutter speed, an aperture value, and an exposure correction value on a lower part of a display screen defined in a finder frame 9a (see FIG. 2).

The phase difference AF module 25 is arranged underneath the mirror box 26, and is adapted to detect the focal position by a well-known phase difference detecting system. An example of the construction of the phase difference AF module 25 is disclosed in Japanese Unexamined Patent Publication No. 11-84226. Detailed explanation on the construction of the phase difference AF module 25 is omitted herein.

The mirror box 26 has a quick return mirror 27 and a sub mirror 28. The position of the quick return mirror 27 is pivotally changeable about a pivot pin 29 between a position as shown by the solid line in FIG. 3 (hereinafter, called as a “tilt position of the quick return mirror 27”) where the quick return mirror 27 is titled by about 45 degrees with respect to the optical axis L of the photographic optical system 20, and a position as shown by the imaginary line in FIG. 3 (hereinafter, called as a “horizontal position of the quick return mirror 27”) where the quick return mirror 27 is aligned substantially parallel to the bottom face of the apparatus body 1A.

The sub mirror 28 is arranged behind the quick return mirror 27, namely, on the side of the image sensor 19. The position of the sub mirror 28 is changeable in association with the movement of the quick return mirror 27 between a position as shown by the solid line in FIG. 3 (hereinafter, called as a “tilt position of the sub mirror 28”) where the sub mirror 28 is titled by about 90 degrees with respect to the quick return mirror 27 at the tilt position, and a position as shown by the imaginary line in FIG. 3 (hereinafter, called as a “horizontal position of the sub mirror 28”) where the sub mirror 28 is aligned substantially parallel to the quick return mirror 27 at the horizontal position. The quick return mirror 27 and the sub mirror 28 are driven by a mirror driving mechanism 51 (see FIG. 4), which will be described later.

While the quick return mirror 27 and the sub mirror 28 are set at their respective tilt positions, namely, for a period until the shutter button 4 is brought to a fully pressed state, the quick return mirror 27 guides a large part of rays of light that have been propagated through the photographic optical system 20 onto the focusing glass 21 for reflection, while allowing the remaining part of the rays of light to pass, and the sub mirror 28 guides the rays of light that have passed through the quick return mirror 27 to the phase difference AF module 25. At this time, the subject image is displayed on the optical viewfinder 9, and focus control is executed by the phase difference AF module 27 according to a phase difference detecting system. However, since the rays of light are not introduced to the image sensor 19 until the shutter button 4 is brought to a fully-pressed state, the subject image is not displayed on the LCD 5.

On the other hand, when the quick return mirror 27 and the sub mirror 28 are set to their respective horizontal positions, namely, when the shutter button 4 is brought to a fully pressed state, the quick return mirror 27 and the sub mirror 28 are retracted from the optical axis L. Accordingly, substantially all the rays that have been propagated through the photographic optical system 20 are incidented to the image sensor 19. At this time, although the subject image is displayed on the LCD 5, the subject image is not displayed on the optical viewfinder 9, and focus control by the phase difference AF module 25 is not implemented.

The light metering sensor 14 is a multi-pattern metering unit comprised of a certain number of light metering blocks arrayed in a matrix, and a certain number of condenser lenses and photoelectric conversion devices, e.g., photodiodes in correspondence to the respective light metering blocks. The light metering sensor 14 is adapted to detect the luminance of a subject image according to a through-the-lens (TTL) system. The light metering sensor 14 has an infrared ray cut filter in front of the imaging plane thereof, so that the spectral sensitivity thereof lies in a visible range. The light metering sensor 14 is designed in such a manner that part of rays of light from the photographic optical system 20 is introduced onto the light metering sensor 14 when the quick return mirror 27 and the sub mirror 28 are set to their respective tilt positions.

The main controller 30 includes a micro computer in which a storage such as an ROM for storing a control program, and a flash memory for temporarily storing data is incorporated. The function of the main controller 30 will be described later in detail.

Now, the lens unit 2 to be attached to the apparatus body 1A is described. As shown in FIG. 3, the lens unit 2 has the photographic optical system 20, the lens barrel 31, the lens driving mechanism 32, a lens encoder 33, and a storage 34.

The photographic optical system 20 is constructed in such a manner that the zoom lens 35 (see FIG. 4) for changing the zoom ratio or the focal length, the focus lens 36 (see FIG. 4) for controlling the focal position, a diaphragm 37 for controlling the amount of light to be irradiated onto the image sensor 19 or a like device provided in the apparatus body 1A are held in the lens barrel 31 in the direction of the optical axis L to guide an optical subject image and to form the optical subject image onto the image sensor 19 or a like device. The image sensor 19 will be described later. The focus control operation is conducted by driving the photographic optical system 20 in the direction of the optical axis L by the AF actuator 16 provided in the apparatus body 1A. The zoom ratio or the focal length is manually changed by an unillustrated zoom ring.

The lens driving mechanism 32 includes a helicoid and an unillustrated gear for rotating the helicoid. The lens driving mechanism 32 is adapted to move the photographic optical system 20 as a unit in the direction of the arrow A parallel to the optical axis L upon receiving a driving force from the AF actuator 16 by way of a coupler 38. The moving direction and the moving distance of the photographic optical system 20 are determined based on the rotation direction and the rotation number of the AF actuator 16, respectively.

The lens encoder 33 includes an encoder plate in which plural code patterns are formed at a certain pitch in the direction of the optical axis L within a movable range of the photographic optical system 20, and an encoder brush which is integrally moved with the lens barrel 31 in sliding contact with the encoder plate. The lens encoder 33 is adapted to detect the moving distance of the photographic optical system 20 at the time of focus control.

The storage 34 is adapted to provide storage contents to the main controller 30 in the apparatus body 1A in response to attachment of the lens unit 2 to the apparatus body 1A, and in response to data request from the main controller 30. The storage section stores therein information relating to a moving distance of the photographic optical system 20 sent from the lens encoder 33, and the like.

Next, an electrical configuration of the image sensing apparatus 1 embodying the invention is described. FIG. 4 is a block diagram showing the electrical configuration of the entirety of the image sensing apparatus 1 in a state that the lens unit 2 is attached to the apparatus body 1A. Elements in FIG. 4 which are equivalent to those in FIGS. 1 through 3 are denoted at the same reference numerals. The parts shown by the dotted lines in FIG. 4 represent parts to be loaded in the lens unit 2. The photographic optical system 20 includes the zoom lens 35 for changing the zoom ratio or the focal length, and the focus lens 36 for controlling the focal position.

Referring to FIG. 5 showing a schematic arrangement of the image sensor 19, the image sensor 19 has a multitude of pixels 40 arrayed in a matrix. Each pixel 40 has a photodiode 41 serving as a photoelectric conversion device for performing photoelectric conversion, a vertical selection switch 42 for selecting the pixel 40 from which a pixel signal is outputted, a reset switch (Rst) 39, and an amplification device 61.

The image sensor 19 further includes a vertical scanning circuit 44 for outputting a vertical scanning pulse ΦVn to vertical scanning lines 43 to each of which control electrodes of the vertical selection switches 42 in each of the pixel rows are commonly connected, horizontal scanning lines 45 to each of which main electrodes of the vertical selection switches 42 in each of the pixel columns are commonly connected, reset lines 62 to which the reset switches 39 of the respective pixels 40 are commonly connected, a sampling circuit 50 which is connected to the horizontal scanning lines 45, horizontal switches 47 which are connected to the sampling circuit 50 and to a horizontal scanning line 48, the horizontal scanning line 48 being connected to control electrodes of the respective horizontal switches 47, an amplifier 49 which is connected to a horizontal signal line 46, and the horizontal signal line 46 being connected to output terminals of the respective horizontal switches 47 and to an output terminal of the amplifier 49. The amplifier devices 61 and the reset switches 39 are connected to a power source Vp.

The sampling circuit 50 is adapted to sample analog pixel signals outputted from the respective pixels 40 to reduce noise components in the pixel signals. An operation of the sampling circuit 50 will be described later. The amplifier 49 is adapted to convert an output signal from the sampling circuit 50 into an electrical voltage.

In the image sensor 19 having the above arrangement, electrical charges accumulated in the respective pixels are outputted pixel by pixel, and a target pixel can be specified to cause the pixel to output the electrical charge accumulated therein by controlling the operations of the vertical scanning circuit 44 and the sampling circuit 50.

Specifically, the vertical scanning circuit 44 is operative to cause the corresponding one of the horizontal scanning lines 45 to output the electrical charge in a target pixel 40 that has undergone photoelectrical conversion by the corresponding photodiode 41 via the corresponding amplifier device 61 and the corresponding vertical selection switch 42, or to set the electrical charge to a certain reset potential via the corresponding reset switch 39. Thereafter, a difference between the electrical charge outputted from the horizontal scanning line 45, and the electrical charge that has been fixed to the reset potential is sampled as an analog pixel signal by the sampling circuit 50. This operation is cyclically carried out with respect to each of the pixels 40, thereby causing all the pixels 40 to sequentially output the electrical charges accumulated therein in a certain order while designating the pixels. The output signals from the sampling circuit 50 are outputted to the amplifier 49 by way of the horizontal switches 47, amplified by the amplifier 49, and outputted to an analog-to-digital (A/D) converter 52, which will be described later.

Image capturing operations such as start and end of an exposure operation of the image sensor 19, and readout of pixel signals from the respective pixels 40 of the image sensor 19 are controlled by a timing controlling circuit 53, which will be described later.

Referring back to FIG. 4, the mirror driving mechanism 51 is adapted to drivingly change the positions of the quick return mirror 27 and the sub mirror 28 between their respective tilt positions and horizontal positions.

The analog-to-digital (A/D) converter 52 is adapted to convert analog pixel signals of R, G, and B which have been outputted from the image sensor 19 into respective digital pixel signals (hereinafter, called as “pixel data”) of plural bits, e.g., 10 bits.

The timing controlling circuit 53 generates clocks CLK1 and CLK2 based on a reference clock CLK0 outputted from the main controller 30. The timing controlling circuit 53 controls operations of the image sensor 19 and the A/D converter 52 by outputting the clock CLK1 to the image sensor 19, and the clock CLK2 to the A/D converter 52, respectively.

An image memory 54 is a memory for temporarily storing image data outputted from the A/D converter 52, and is used as a work area where various processing are applied to the image data by the main controller 30 when the image sensing apparatus 1 is in the image shooting mode. The image memory 54 serves as a memory for temporarily storing image data read out from an image storage 56, which will be described later, when the image sensing apparatus 1 is in the playback mode.

An image processing section 55 includes a black level correction unit for converting the black level of image data stored in the image memory 54 into a reference black level, a white balance correction unit for performing level conversion of pixel data of the respective color components of R, G, and B, and a gamma correction unit for performing gamma correction to obtain intended gamma characteristics of the pixel data.

The image storage 56 includes a memory card and a hard disk, and is adapted to store image data generated in the main controller 30. An mput/operating section 57 is constituted of the first mode setting dial 3, the shutter button 4, the setting button group 6, the jog dial 7, the push button 8, the main switch 10, and the second mode setting dial 11. Through the input/operating section 57, information relating to an operation of the image sensing apparatus 1 is inputted to the main controller 30. A VRAM 60 has a storage capacity capable of recording image signals corresponding to the number of pixels of a LCD 5, and serves as a buffer memory for storing pixel data constituting an image to be played back on the LCD 5. The LCD 5 in FIG. 4 corresponds to the LCD 5 in FIG. 2.

The main controller 30 corresponds to the main controller 30 shown in FIG. 3, and is adapted to control driving of the respective parts in the image sensing apparatus 1 shown in FIG. 4 in association with each other.

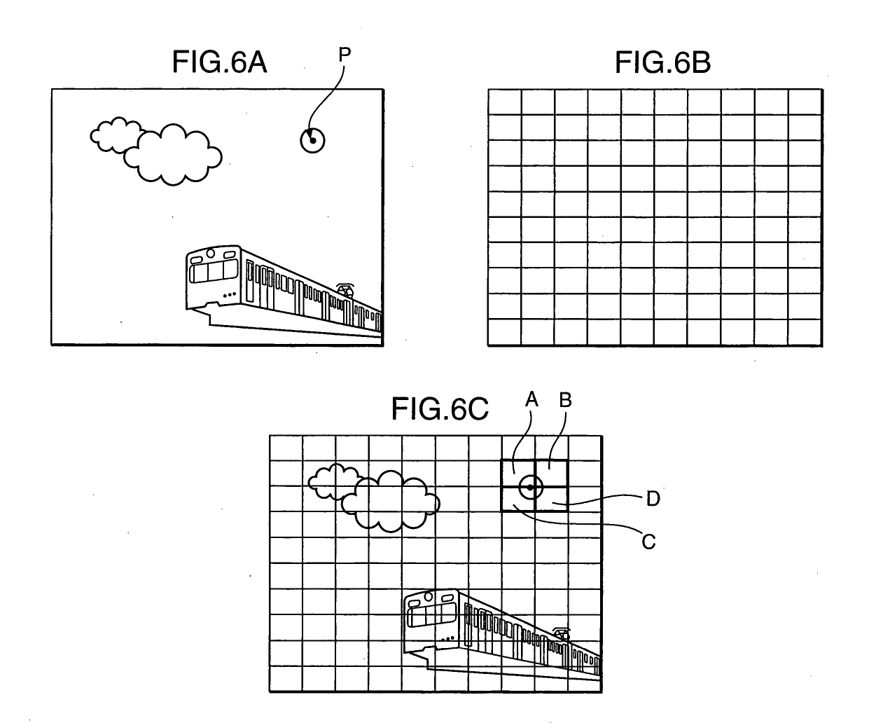

Generally, a CMOS color area sensor as an image sensor has the following drawback. If a subject such as the sun having an extremely high luminance is to be captured by the image sensor, as shown in FIG. 6A, there is a case that a subject image which is supposed to have a high luminance, e.g., the image of the sun in FIG. 6A is captured in black as shown by the black dot shown by the arrow P in FIG. 6A. Hereinafter, this phenomenon is called as “inversion”. The following is conceived to be one of the reasons for occurrence of the inversion.

Specifically, in this embodiment, since a mechanical shutter for blocking light introduced from the photographic optical system 20 between the photographic optical system 20 and the image sensor 19 is not provided, termination of an exposure operation of the image sensor 19, and readout of pixel signals generated by the exposure operation are performed by an electronic shutter in combination with the relevant devices incorporated in the image sensor 19 based on designation from the main controller 30.

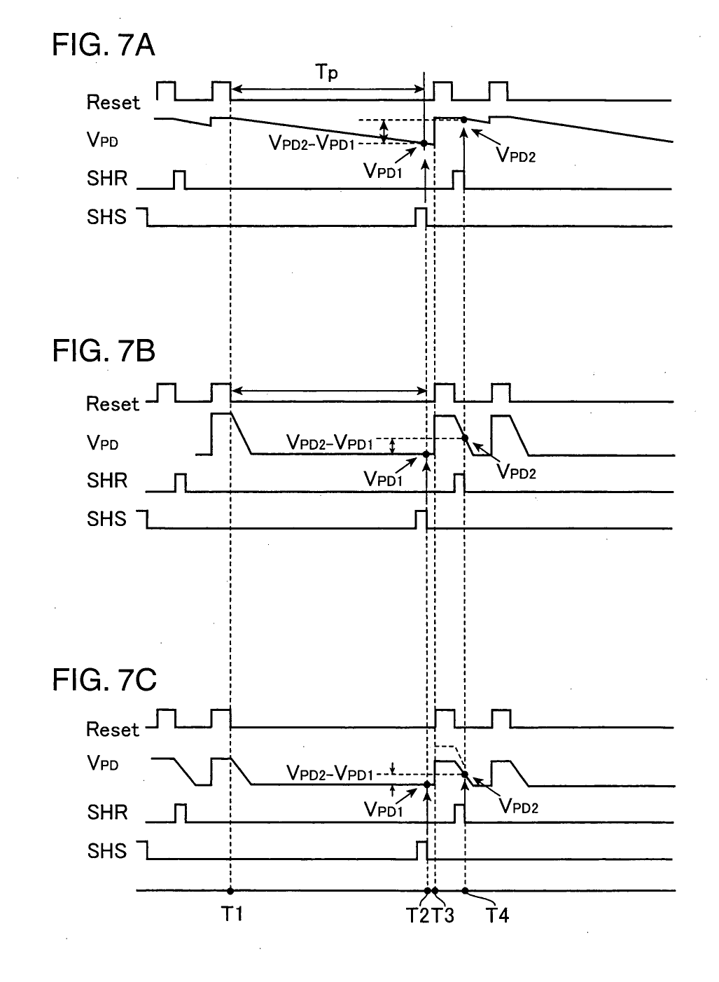

An operation of the respective pixels executed by the electronic shutter is described. FIGS. 7A through 7C are timing charts for explaining operations of a pixel 40 of the image sensor 19. In FIGS. 7A through 7C, “Reset” represents a reset pulse to be outputted from the vertical scanning circuit 44 to the corresponding reset switch 39, “VPD” represents a cathode voltage of the photodiode 41 at the pixel 40. “SHR” represents a reset sample-holding pulse for determining a timing for sampling the voltage VPD after a reset operation by the sampling circuit 50. “SHS” represents a signal sample-holding pulse for determining a timing for sampling the voltage VPD corresponding to a pixel signal constituting an image. SHR and SHS are integrally represented as a timing pulse CLK2 in FIG. 4.

As shown in FIG. 7A, in capturing a subject image, first, the vertical scanning circuit 44 turns on the reset switch 39 to discharge the electrical charge accumulated in the photodiode 41 at the timing T(=T1).

Then, upon lapse of a predetermined duration from the timing T(=T1), the main controller 30 outputs the pulse SHS. Thereby, the sampling circuit 50 samples the cathode voltage VPD of the photodiode 41 at the timing T(=T2). The voltage VPD acquired by the sampling operation of the sampling circuit 50 is represented as a voltage VPD1. A time duration from the timing T1 to the timing T2 corresponds to an exposure time Tp.

Then, at the timing T(=T3) after lapse of a certain duration from the timing T(=T2), the reset switch 39 is turned on to discharge the electrical charge accumulated in the photodiode 41. Immediately after the electrical charge discharging operation, the main controller 30 outputs the pulse SHR. Then, the sampling circuit 50 samples the cathode voltage VPD of the photodiode 41 after the reset operation at the timing T(=T4). The voltage VPD acquired by the sampling operation is represented as a voltage VPD2.

The sampling circuit 50 obtains a difference (VPD2−VPD1) between the voltage VPD1 and the voltage VPD2 which have been acquired by the respective sampling operations. The voltage difference (VPD2−VPD1) is set as a signal level corresponding to a pixel signal of the subject image acquired by the exposure operation of the pixel.

The above operation is carried out sequentially with respect to the pixels from the uppermost horizontal pixel row toward the lowermost horizontal pixel row, and from the leftmost pixel to the rightmost pixel in each of the horizontal pixel rows in FIG. 5. By implementing this operation, even if the image sensor 19 performs a reset operation at the timing T(=T1), for instance, a noise analogous to a residue noise in the pixel is removed from the pixel signal constituting the image, whereby high image reproducibility is ensured with respect to the subject image.

In controlling the pixel in the aforementioned manner, the cathode voltage VPD of the photodiode 41 is temporarily raised to a predetermined level in response to turning on of the reset switch 39, followed by falling. The manner of falling of the voltage VPD differs depending on the intensity of light to be incident onto the pixel.

Specifically, as shown in FIG. 7A, in the case where the intensity of light to be incident onto the pixel is relatively weak, the voltage VPD is gradually attenuated until the reset switch 39 is turned on again. On the other hand, in the case where the intensity of light to be incident onto the pixel is significantly high, a large amount of electrical charge is accumulated in the pixel even in a short time. Accordingly, as shown in FIG. 7B, as compared with the example of FIG. 7A, the voltage VPD sharply falls, in other words, the pixel is instantaneously saturated.

As mentioned above, the voltage difference (VPD2−VPD1) derived from each of the pixels is set as the pixel signal of the target pixel. Accordingly, if the intensity of light to be incident onto the target pixel is significantly high, the voltage difference (VPD2−VPD1) is significantly small, as compared with the example of FIG. 7A where the intensity of light to be incident onto the pixel is relatively low.

FIG. 7C shows an example of a change of the voltage VPD in the case where the intensity of light to be incident onto the pixel is much higher than the example of FIG. 7B. In this case, the pixel is instantaneously saturated before the voltage VPD is raised to the predetermined level even if the reset switch 39 is turned on. Accordingly, the voltage difference (VPD2−VPD1) is much smaller, as compared with the example of FIG. 7B.

In this way, if the voltage difference (VPD2−VPD1) is extremely small, the luminance of the subject image captured by the exposure operation of the pixel is extremely small, with the result that the subject image having such a small luminance is captured in black. In this embodiment, proposed is a technique of avoiding or suppressing occurrence of inversion or generation of a defective image, in which an image area supposed to be captured as a region having a high luminance is captured in black.

In the image sensing apparatus 1 according to this embodiment, as mentioned above, rays of light are not incident onto the image sensor 19 until the shutter button 4 is brought to a fully pressed state because the quick return mirror 27 is kept to a tilted position until the shutter button 4 is brought to the fully pressed state. Therefore, there is no likelihood that inversion may occur until the shutter button 4 is fully pressed.

In this embodiment, inversion may occur in an image to be recorded, which is generated by setting the shutter button 4 to a fully pressed state. As shown in FIG. 4, the main controller 30 functionally has a judger 58 and a data corrector 59 to eliminate likelihood of occurrence of inversion in the image to be recorded.

Inversion may occur in capturing a subject image having an extremely high luminance such as the sun. In light of the fact that the dynamic range of the image sensor 19 is not so wide, namely, the output signal intensity of the image sensor 19 is not so strong, there is a case that the image sensor 19 may output pixel signals or output values identical to each other from subject images having different luminances, e.g., the sun and an electrical lamp, if the luminances of the two subject images exceed a predetermined luminance. In such a case, it is difficult to discriminate the one of the subject images from the other based on the output values of the image sensor 19.

In this embodiment, in light of the fact that the light metering sensor 14 has a wider dynamic range than that of the image sensor 19, a subject image with a possibility of inversion is discriminated from a subject image without a possibility of inversion with use of a detection signal from the light metering sensor 14 to extract the subject image with a possibility of inversion.

The judger 58 judges whether inversion has occurred with respect to the pixel data generated in response to fully pressing of the shutter button 4 with use of a detection signal from the light metering sensor 14.

FIG. 6A shows an image capturing area of the image sensor 19. FIG. 6B shows a light metering area of the light metering sensor 14. FIG. 6C shows a corresponding relation between the image capturing area of the image sensor 19 and the light metering area of the light metering sensor 14. As shown in FIG. 6B, the light metering sensor 14 has a certain number of light metering blocks divided in a matrix format. Description is made on a premise that the light metering area of the light metering sensor 14 and the image capturing area of the image sensor 19 are substantially coincident with each other.

The judger 58 receives output data from the respective light metering blocks of the light metering sensor 14 until the shutter button 4 is brought to a fully pressed state, and acquires subject luminances with respect to the respective light metering blocks to retrieve a light metering block having a possibility of inversion based on the acquired subject luminances. Specifically, the judger 58 retrieves a light metering block having a subject luminance which exceeds a predetermined threshold value. In this embodiment, a possible maximal output value to be outputted from the pixels is set as the predetermined threshold value (hereinafter, called as “saturated value”.

The judger 58 extracts a portion of the image capturing area of the image sensor 19, which corresponds to the light metering block having a possibility of inversion, as an image capturing block having a possibility of inversion. In this example, image capturing blocks A through D as shown in FIG. 6C are extracted as the image capturing block having a possibility of inversion.

In response to output of the pixel data for recording from the image sensor 19 by the fully pressing of the shutter button 4, the data corrector 59 performs the following correction with respect to the pixel data for recording in the image capturing blocks A through D extracted by the judger 58 as follows.

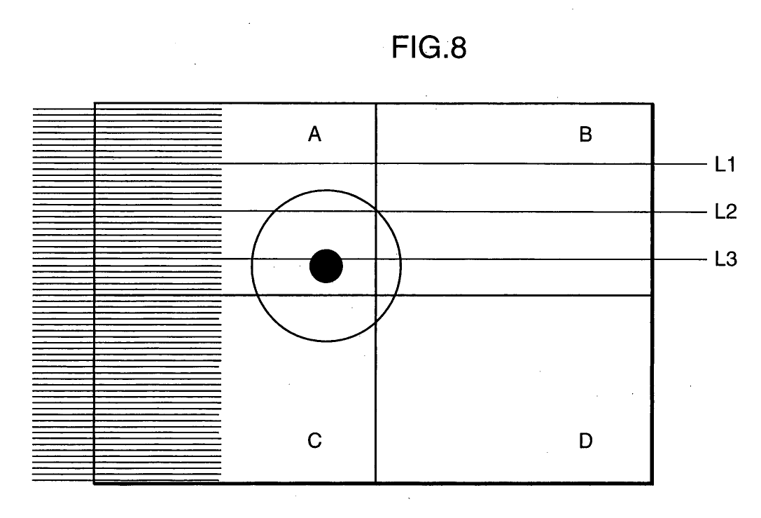

Specifically, as shown in FIG. 8, the data corrector 59 detects a change in pixel data, namely, in output value in the extracted image capturing blocks A through D in a predetermined pixel array direction. For instance, the data corrector 59 detects the pixel data change, namely, the output value change of the pixels belonging to the image capturing blocks A through D, from the uppermost horizontal pixel row toward the lowermost horizontal pixel row, and from the leftmost pixel toward the rightmost pixel in each of the horizontal pixel row.

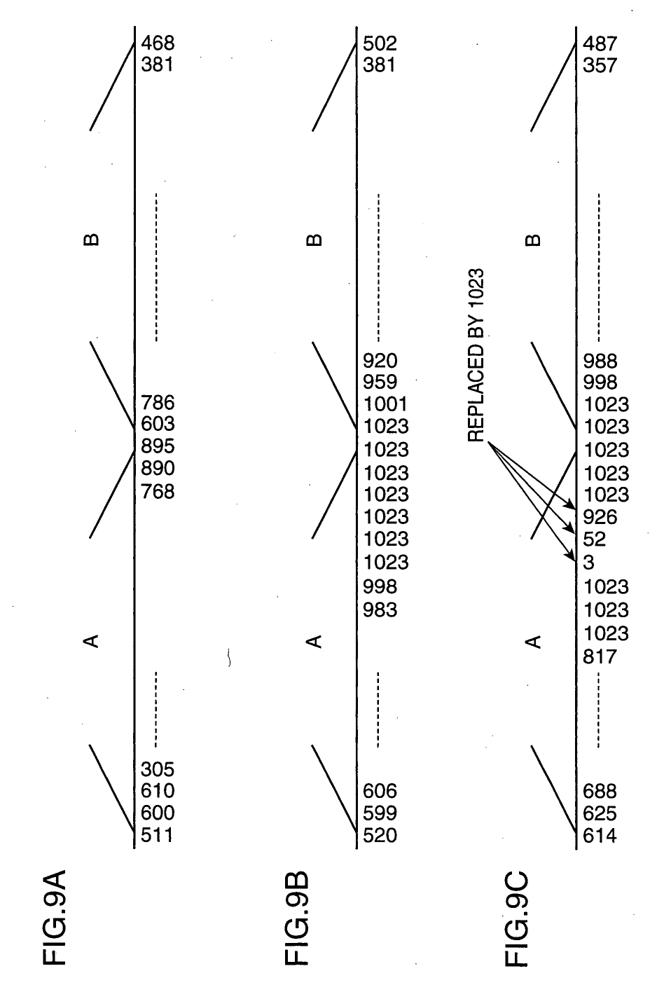

Observing the pixel data change of the pixels arrayed in the horizontal direction, there are conceived three variation patterns as shown in FIGS. 9A through 9C. In FIGS. 9A through 9C, the numerical values represent values of respective pixel data, 0 is a possible minimal value to be outputted from the pixels, and 1023 is the saturated value. The symbols “A” and “B” in FIGS. 9A through 9C correspond to the image capturing blocks A and B shown in FIGS. 6C and 8.

FIG. 9A shows a horizontal pixel row L1 shown in FIG. 8, and an arrangement of pixel data outputted from the pixels belonging to the horizontal pixel row L1, and shows a variation pattern in which there is no pixel data having the saturated value. FIG. 9B shows a horizontal pixel row L2 shown in FIG. 8, and an arrangement of pixel data outputted from the pixels belonging to the horizontal pixel row L2, and shows a variation pattern, in which there is no pixel data of a value smaller than the saturated value between pixel data of the saturated values. FIG. 9C shows a horizontal pixel row L3 shown in FIG. 8, and an arrangement of pixel data outputted from the pixels belonging to the horizontal pixel row L3, and shows a variation pattern, in which there exists pixel data of a value smaller than the saturated value between pixel data of the saturated values.

In the above condition, let us observe the respective pixel data, namely, the output values from the pixels arrayed in the horizontal direction. If inversion has occurred, there exists pixel data of a value smaller than the saturated value between pixel data of the saturated values. Therefore, it is conceived that the variation pattern as shown in FIG. 9C may include a pixel having a possibility of inversion.

The data corrector 59 judges whether the extracted image capturing block includes a pixel with a possibility of inversion based on the variation patterns. If the data corrector 59 detects the variation pattern shown in FIG. 9C, it is judged that the pixel which lies between the pixels having the pixel data of the saturated values and which outputs pixel data of a value smaller than the saturated value has a possibility of inversion. Hereinafter, the pixel having a possibility of inversion is called as a “possibly inverted pixel”. Then, the value of the pixel data of the possibly inverted pixel is replaced by the saturated value in response to acquisition of the pixel data for recording by an exposure operation of fully pressing of the shutter button 4.

For instance, in the variation pattern shown in FIG. 9C, the values “926”, “52”, and “3” of the pixel data are replaced by the saturated value “1023”. In this embodiment, if the variation pattern having pixel data of a value smaller than the saturated value between pixel data of the saturated values is detected, the value of the pixel data smaller than the saturated value is replaced by the saturated value. Alternatively, it is possible to set a threshold value for pixel data replacement, and to replace a value of pixel data smaller than the second threshold value by the saturated value. In such an altered arrangement, a value smaller than the saturated value by a value corresponding to 1% of the saturated value may be set as the second threshold value.

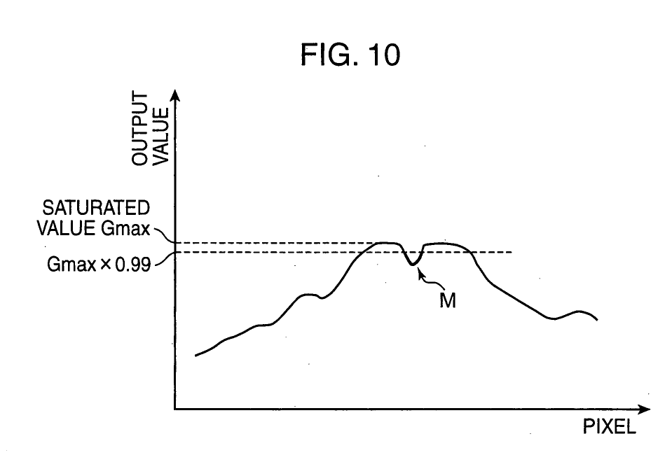

For instance, if output values shown in FIG. 10 are obtained from the respective pixels belonging to a certain horizontal pixel row, it is preferable to set the second threshold value to, e.g., a value (=saturated value Gmax×99%). The saturated value Gmax corresponds to the first threshold value. Referring to FIG. 10, as shown by the arrow M, the aforementioned pixel data replacement is carried out with respect to a pixel signal having an output value smaller than the second threshold value as represented by the lower dotted line.

Performing the above operation enables to prevent or suppress generation of a black dot as shown by the arrow P in FIG. 6A, and to capture an image corresponding to the black dot with a brightness substantially equal to the brightness of a subject image near the black dot image. If the variation patterns shown in FIGS. 9A and 9B are detected, the data corrector 59 does not implement the pixel data replacement.

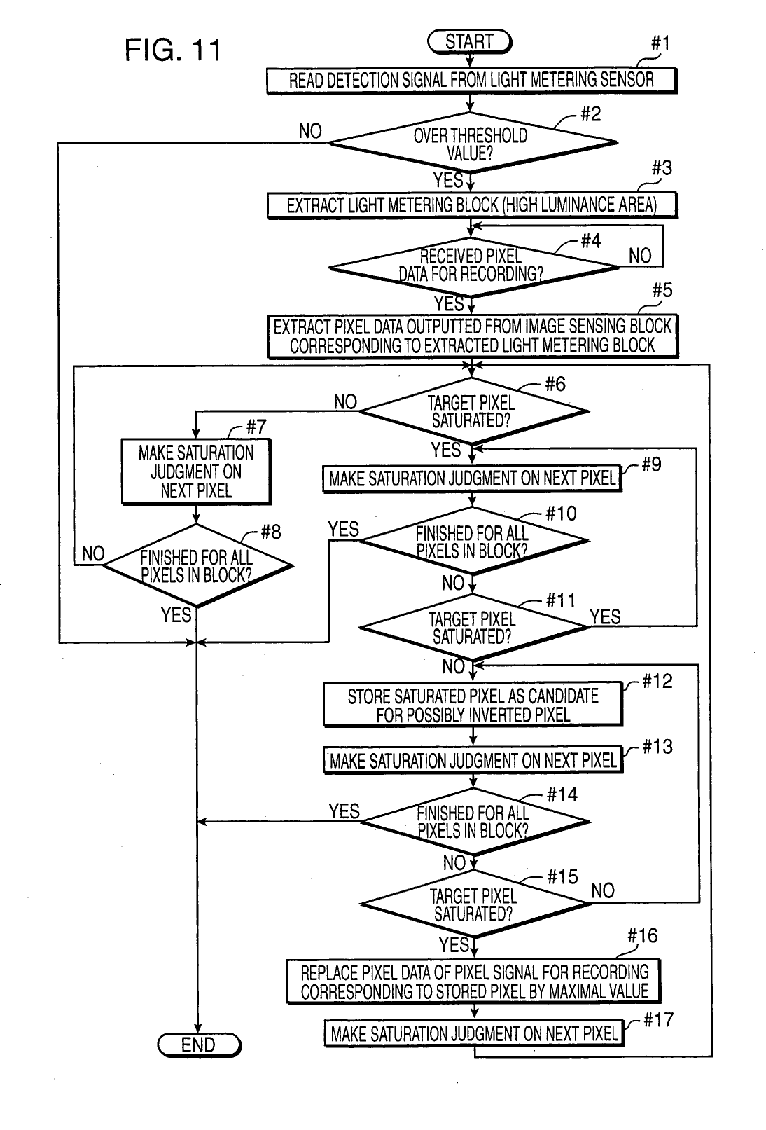

Next, the above correction processing to be implemented by the image sensing apparatus 1 is described referring to the flowchart shown in FIG. 11.

Referring to FIG. 11, the main controller 30 reads out a detection signal from the light metering sensor 14 (Step #1). Then, the main controller 30 judges whether the detection signal exceeds a predetermined threshold value (Step #2). If it is judged that the detection signal does not exceed the threshold value (NO in Step #2), the main controller 30 terminates the processing. On the other hand, if it is judged that the detection signal exceeds the threshold value (YES in Step #2), the main controller 30 extracts a light metering block having a detection signal of a value larger than the threshold value as a high luminance region (Step #3).

Subsequently, upon receiving pixel data for recording (YES in Step #4), the main controller 30 extracts the pixel data for recording, which has been outputted from the image capturing block of the image sensor 19 corresponding to the light metering block extracted in Step #3 (Step #5).

Then, as shown in FIG. 8, the main controller 30 detects a pixel data change from the uppermost horizontal pixel row toward the lowermost horizontal pixel row, and from the leftmost pixel toward the rightmost pixel in each of the horizontal pixel rows. Specifically, the main controller 30 judges whether a target pixel is saturated (Step #6). If the main controller 30 judges that the target pixel is not saturated (NO in Step #6), the main controller 30 makes a judgment as to saturation of the pixel with respect to a pixel succeeding the target pixel (Step #7). Then, the main controller 30 judges whether the judgment as to saturation of the pixel has been made with respect to all the pixels belonging to the extracted image capturing block (Step #8). If the main controller 30 judges that the judgment as to saturation of the pixel is not completed with respect to all the pixels belonging to the extracted image capturing block (NO in Step #8), the main controller 30 returns to Step #6.

If the main controller 30 judges that the target pixel is saturated (YES in Step #6), the main controller 30 makes a judgment as to saturation of the pixel with respect to a pixel succeeding the target pixel (Step #9), and judges whether the judgment as to saturation of the pixel has been made with respect to all the pixels belonging to the extracted image capturing block (Step #10). If the main controller 30 judges that the judgment as to saturation of the pixel is completed with respect to all the pixels belonging to the extracted image capturing block (YES in Step #10), the main controller 30 terminates the processing. On the other hand, if the main controller 30 judges that the judgment as to saturation of the pixel is not completed with respect to all the pixels belonging to the extracted image capturing block (NO in Step #10), the main controller 30 judges whether the newly targeted pixel in Step #9 is saturated (Step #11).

If the main controller 30 judges that the newly targeted pixel is saturated (YES in Step #11), the main controller 30 returns to Step #9. If the main controller 30 judges that the newly targeted pixel is not saturated (NO in Step #11), the main controller 30 stores the newly targeted pixel as a candidate for a possibly inverted pixel (Step #12).

Then, the main controller 30 makes a judgment as to saturation of the pixel with respect to a pixel succeeding the target pixel (Step #13), and judges whether the judgment as to saturation of the pixel has been made with respect to all the pixels belonging to the extracted image capturing block (Step #14). If the main controller 30 judges that the judgment is completed with respect to all the pixels belonging to the extracted image capturing block (YES in Step #14), the main controller 30 terminates the processing. If the main controller 30 judges that the judgment is not completed with respect to all the pixels belonging to the extracted image capturing block (NO in Step #14), the main controller 30 judges whether the target pixel is saturated (Step #15).

If the main controller 30 judges that the target pixel is not saturated (NO in Step #15), the main controller 30 returns to Step #12. If the main controller 30 judges that the target pixel is saturated (YES in Step #15), the main controller 30 performs the pixel data replacement with respect to the pixel data for recording, which corresponds to the pixel stored as the candidate for the possibly inverted pixel (Step #16), makes a judgment as to saturation of the pixel with respect to a pixel succeeding the target pixel (Step #17), and returns to Step #6.

If the main controller 30 judges that the target pixel is saturated (YES in Step #6), the main controller 30 executes the operations from Step #9 and thereafter. If the main controller 30 judges that the target pixel is not saturated (NO in Step #6), and completes a judgment as to saturation of the pixel with respect to all the pixels belonging to the extracted image capturing block (YES in Step #8) after the operation in Step #7, the main controller 30 terminates the processing.

As mentioned above, in the case where it is judged that a possibly inverted pixel is included, occurrence of inversion is detected based on a judgment as to whether pixel data of a value smaller than the saturated value exists between pixel data of the saturated values in retrieving pixel data from the pixels arrayed in the horizontal direction. If it is judged that a possibly inverted pixel is included, the value of the pixel data of the possibly inverted pixel is replaced by the saturated value. This arrangement enables to avoid likelihood that a defective image such as an image having a black dot in the center of an image of the sun may be captured, thereby securing high image reproducibility with respect to the subject image.

Further, a high luminance region with a possibility of inversion is extracted with use of a detection signal from the light metering sensor 14 having a dynamic range wider than that of the image sensor 19. This arrangement enables to accurately discriminate a subject image with a possibility of inversion from a subject image without a possibility of inversion.

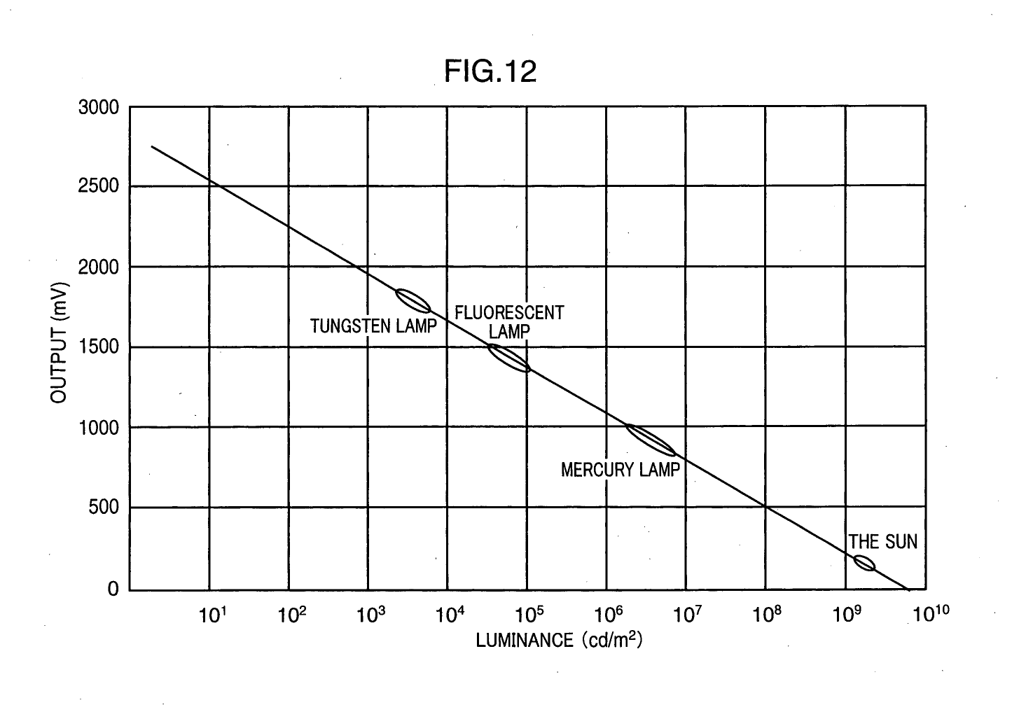

FIG. 12 is a graph showing a relation between a luminance of a subject image along a horizontal axis, and an output of the light metering sensor 14 in correspondence to the luminance along a vertical axis.

For instance, if the image sensor 19 receives light from a fluorescent lamp, a tungsten lamp, a mercury lamp, and the sun, there is a case that the image sensor 19 outputs saturated values with respect to all the light irradiated from these different light sources. Since the dynamic range of the light metering sensor 14 is wider than that of the image sensor 19, as shown in FIG. 12, output data from the light metering sensor 14 are varied depending on the intensity of light irradiated from these different light sources. Specifically, as shown in FIG. 12, the light metering sensor 14 has optical characteristics such that the output of the light metering sensor 14 is decreased substantially in proportion to increase in the subject luminance, and the output of the light metering sensor 14 is varied depending on the intensity of light irradiated from the fluorescent lamp, the tungsten lamp, the mercury lamp, and the sun having different luminances from each other.

Accordingly, if it is conceived that the sunlight is the only light that may cause inversion among different light from the fluorescent lamp, the tungsten lamp, the mercury lamp, and the sun, as shown in FIG. 12, judgment is made as to whether light received on the respective pixels of the image sensor 19 corresponding to each of the light metering blocks of the light metering sensor 14 is derived from the sunlight or from a light source other than the sun by setting the threshold value for, the output from the light metering sensor 14 at 500 mV. As a result of this control, the image sensing apparatus 1 can accurately discriminate a subject image with a possibility of inversion from a subject image without a possibility of inversion, even if the image sensor 19 outputs saturated values with respect to these subject images.

It is possible to judge whether the pixel data replacement is necessary with respect to all the pixels of the image sensor 19. In the embodiment, as mentioned above, a high luminance region with a possibility of inversion is extracted with use of a detection signal from the light metering sensor 14, and judgment is made as to whether the pixel data replacement is necessary in the extracted high luminance region. This arrangement enables to readily detect the pixel for which the pixel data replacement is necessary, as compared with an arrangement that judgment on the pixel data replacement is made with respect to all the pixels of the image sensor 19.

If it is judged that the extracted high luminance region includes a possibly inverted pixel, the value of the pixel data of the possibly inverted pixel is replaced by the saturated value. This arrangement enables to prevent or suppress occurrence of inversion with a simplified arrangement, as compared with the conventional arrangement.

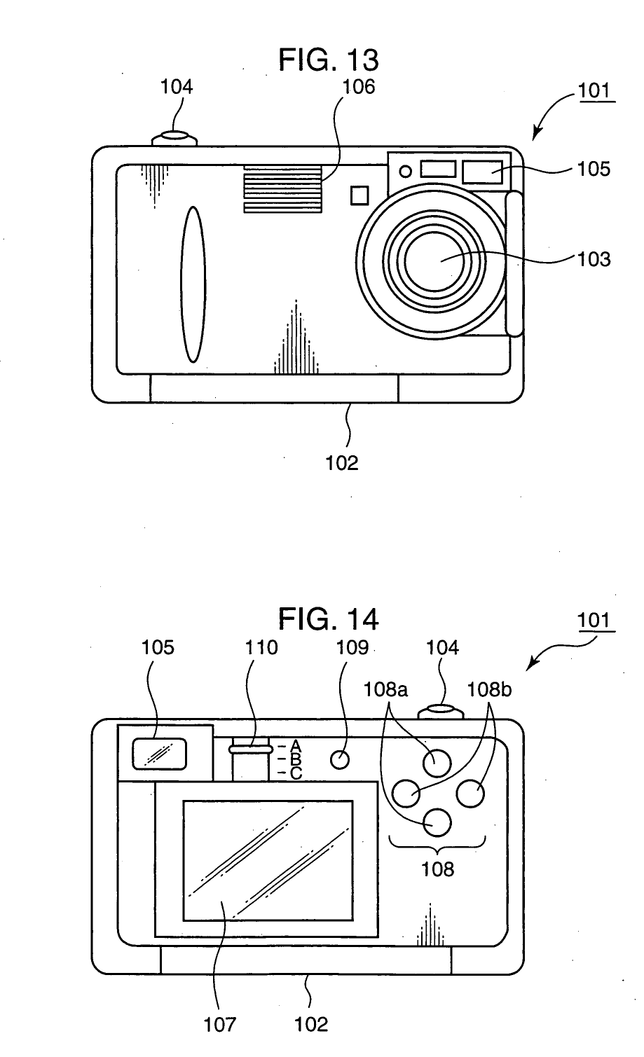

Referring to FIGS. 13 and 14 showing an image sensing apparatus as a second embodiment of the invention, the image sensing apparatus 101 is a so-called “compact camera”, whereas the image sensing apparatus 1 in the first embodiment is a single lens reflex image sensing apparatus. The image sensing apparatus 102 includes a photographic optical system 103, a shutter button 104, an optical viewfinder 105, a flash 106, an LCD 107, a functional switch group 108, a power button 109, and a mode setting switch 110.

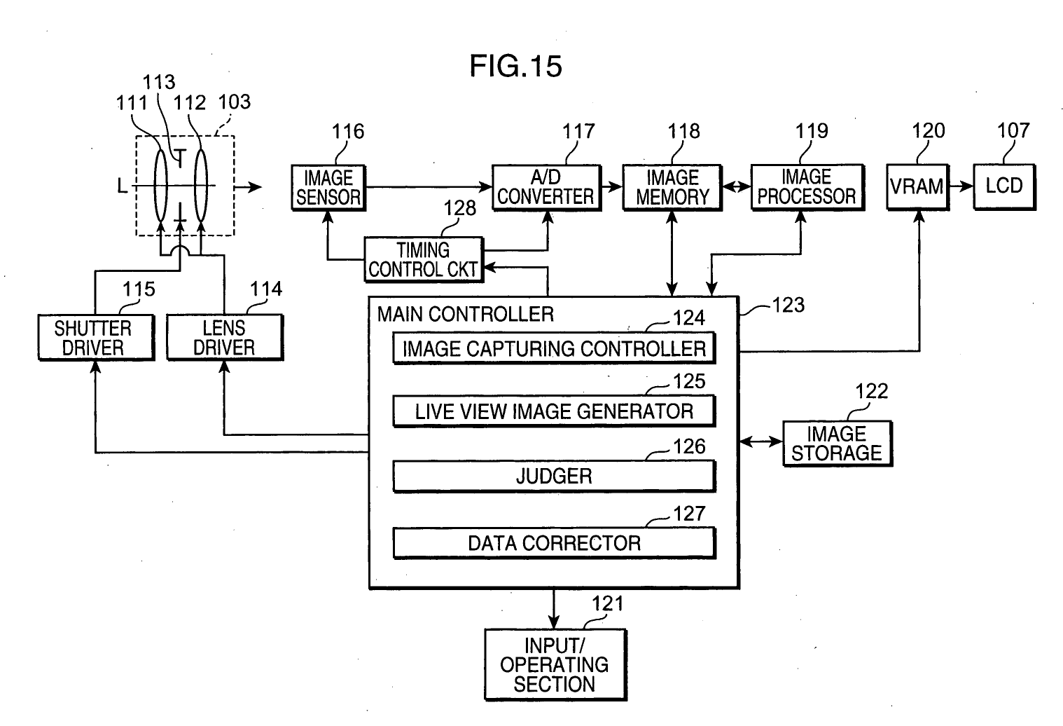

The photographic optical system 103 is arranged on a right side on a front face of an apparatus body 102 to form an optical image of a subject. The photographic optical system 103 has a zoom lens group 111 (see FIG. 15) for changing the angle of view for photographing, a focus lens group 112 (see FIG. 15) for focus control, and a lens shutter 113 (see FIG. 15) so as to change the focal length or adjust the focal point.

The shutter button 104 is of a two-stage operable type constructed such that the shutter button 104 is settable to a halfway pressed state and a fully pressed state. The shutter button 4 is adapted to designate a timing of an exposure operation. The image sensing apparatus 101 has a still image shooting mode of shooting a still image, and a moving image shooting mode of shooting a moving image. In setting the still image shooting mode and the moving image shooting mode, the image sensing apparatus 101 is operated in such a manner that pixel signals are read out from respective pixels of an image sensor 116 (see FIG. 15) by an electronic shutter at a predetermined interval, e.g., 1/30 second while the shutter button 104 is not operated, so that a subject image, namely, a live-view image is updated and displayed on the LCD 107.

The live-view image is cyclically displayed on the LCD 107 at a predetermined interval, e.g., 1/30 second until a subject image is recorded, namely, during a photographing preparatory period. The live-view image is an image captured by the image sensor 116. A state of the subject image is displayed on the LCD 107 substantially on a real-time basis by way of the live-view image, so that a photographer can confirm the state of the subject image on the LCD 107.

In the still image shooting mode, when the shutter button 104 is pressed halfway down, the image sensing apparatus 101 is brought to an image shooting standby state, wherein setting of an exposure control value such as a shutter speed of the lens shutter 113 and an aperture value is conducted in addition to the display processing of the live-view image. Further, in the still image shooting mode, when the shutter button 104 is pressed fully down, an exposure operation by the image sensor 116 for recording is initiated to generate a subject image to be recorded in an image storage 122 (see FIG. 15), which will be described later. On the other hand, in the moving image shooting mode, when the shutter button 104 is pressed fully down, the exposure operation for recording is initiated, and pixel signals are read out from the respective pixels of the image sensor 116 by an electronic shutter at a predetermined interval, e.g., 1/30 second to generate images one after another. When the shutter button 104 is pressed fully down again, the exposure operation for recording is terminated.

The optical viewfinder 105 is arranged on an upper left portion on a rear face of the apparatus body 102 to optically display an image capturing area of a subject. The flash 106, which is a build-in flash, is arranged at an upper middle part on the front face of the apparatus body 102 to irradiate illumination light onto the subject by firing unillustrated flashlight if it is judged that a light amount from the subject is insufficient.

The LCD 107 is arranged substantially in the middle on the rear face of the apparatus body 102. The LCD 107 has a color liquid crystal display panel to display an image captured by the image sensor 116, to display a recorded image for playback, and to display a screen image for setting a function or a mode loaded in the image sensing apparatus 101.

The functional switch group 108 is arranged on a right side of the LCD 107, and includes a zoom switch 108a for driving the zoom lens group 111 (see FIG. 15) to a wide-angle limit or a telephoto limit, and a focus switch 108b for focus control, namely for driving the focus lens group 112 in the optical axis direction of the photographic optical system 103.

The power button 109 is arranged on an upper portion on the rear face of the apparatus body 102 and on a left side of the functional switch group 108 to alternately turn on and off the main power of the image sensing apparatus 101 each time the power button 109 is pressed.

The mode setting switch 110 is arranged on the upper portion on the rear face of the apparatus body 102. The mode setting switch 110 is a switch to change over the mode of the image sensing apparatus 101 between the still image shooting mode of shooting a still image of a subject, the moving image shooting mode of shooting a moving image of the subject, and a playback mode of displaying a captured image which has been recorded in the image storage 122 (see FIG. 15) for playback on the LCD 107. The mode setting switch 110 is a slide switch of 3-contact, which slides up and down in the image sensing apparatus 101. When the mode setting switch 110 is set to a down end position, the image sensing apparatus 101 is set to the playback mode. When the mode setting switch 110 is set to the middle position, the image sensing apparatus 101 is set to the still image shooting mode. When the mode setting switch 110 is set to an upper end position, the image sensing apparatus 101 is set to the moving image shooting mode.

Next, an electrical configuration of the image sensing apparatus 101 is described referring to FIG. 15. Elements in FIG. 15 which are identical or equivalent to those in FIGS. 13 and 14 are denoted at the same reference numerals.

A lens driver 114 has an actuator for driving the zoom lens group 111 and the focus lens group 112 in the optical axis direction of the photographic optical system 103. A shutter driver 115 has an actuator for driving the lens shutter 113.

The image sensor 116, an analog-to-digital (A/D) converter 117, and a timing controlling circuit 128 in the second embodiment have substantially the same arrangement as the image sensor 19, the A/D converter 52, and the timing controlling circuit 53 in the first embodiment. An image memory 118, an image processor 119, and a VRAM 120 in the second embodiment have substantially the same arrangement as the image memory 54, the image processor 55, and the VRAM 60 in the first embodiment. An input/operating section 121 includes the shutter button 104, the functional switch group 108, the power button 109, and the mode setting switch 110 to input information relating to operations of the image sensing apparatus 101 to a main controller 123. The image storage 122 in the second embodiment has substantially the same arrangement as the image storage 56 in the first embodiment.

The main controller 123 has a micro computer, and controls an overall image shooting operation of the image sensing apparatus 101 by controlling driving of the respective parts in the apparatus body 102 in association with each other. The main controller 123 includes an unillustrated storage comprised of a RAM as a work area for a CPU, and a ROM on which a program or the like for executing various functions loaded in the image sensing apparatus 101 is recorded.

In this embodiment, the image sensing apparatus 101 has the lens shutter 113. The lens shutter 113 blocks light from being incident onto the image sensor 116 at the time of generating an image for recording. Accordingly, there is not the likelihood or possibility of inversion when an image is generated for recording. However, a live-view image, which is generated until generation of an image for recording is designated, namely, until the shutter button 104 is brought to a fully pressed state, and a moving image, which is generated in the moving image shooting mode, are generated by the electronic shutter. In this case, there is a possibility of inversion. In view of this, in this embodiment, a correction processing is performed on the live-view image and the moving image to eliminate or suppress occurrence of inversion.

Since the image sensing apparatus 101 does not have a light metering sensor as in the first embodiment, it is impossible to discriminate a high luminance subject image with a possibility of inversion from a high luminance subject image without a possibility of inversion with use of output data from a light metering sensor. In view of this, in the second embodiment, the following technique is employed to accurately discriminate a high luminance subject image with a possibility of inversion from a high luminance subject image without a possibility of inversion so as to eliminate or suppress occurrence of inversion. Hereinafter, described is a case in which this technique is applied to a live-view image.

A live-view image is generated with use of part of pixel data outputted from the pixels of the image sensor 116, namely, by skipping readout operation of pixel data. Since pixel data outputted from pixels other than the pixels used for the live-image generation has no relation to the live-view image generation, in this embodiment, judgment is made as to whether there is a possibility of inversion in the pixel data outputted from the pixels used for the live-view image generation, with use of pixel data of the pixels other than the pixels used for the live-image generation, and the pixel data used for the live-view image generation is corrected based on a result of the judgment.

The main controller 123 functionally has an image capture controller 124, a live-view image generator 125, a judger 126, and a data corrector 127 to realize the above function.

The image capture controller 124 controls an image capturing operation of the image sensor 116. The live-view image generator 125 generates a live-view image with use of a part of pixel data outputted from the pixels of the image sensor 116, namely by skipping readout operation.

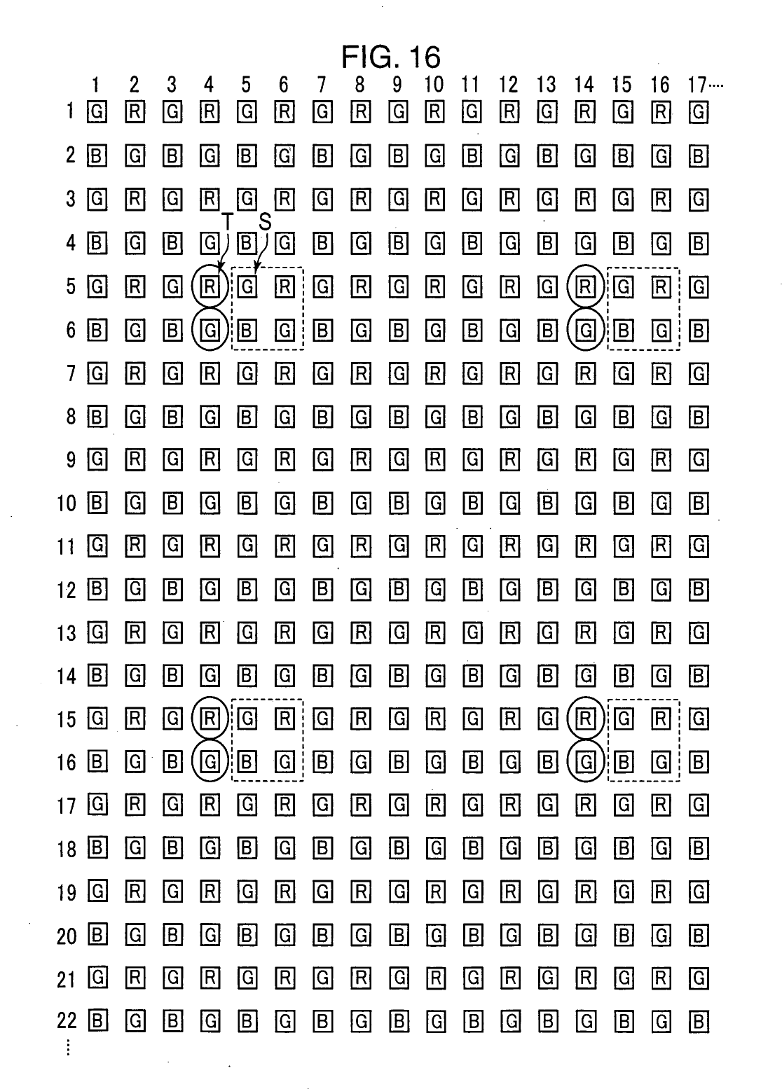

In the following, processing by the image capture controller 124 and the live-view image generator 125 will be described referring to FIGS. 16 through 18B. FIG. 16 is an illustration partly showing an arrangement of the pixels of the image sensor 116.

As shown in FIG. 16, let us define a two-dimensional coordinate system, in which the pixels arrayed in a matrix are numbered in a horizontal direction and in a vertical direction in a certain order, with the pixel at the uppermost row and the leftmost column being set as a reference pixel. Then, the live-view image generator 125 generates a live-view image with use of the pixel data at the pixels (pixel groups enclosed by the dotted lines in FIG. 16) as represented by (10 m-5, 10n-5), (10 m-4, 10n-5), (10 m-5, 10n-4), and (10 m-4, 10n-4) where m and n each is a positive integer. Hereinafter, a pixel for use in generating pixel data constituting a live-view image is called as a “pixel for live-image generation”, and pixel data obtained based on the pixel for live-view image generation during a photographing preparatory period is called as “pixel data for live-view image generation”.

As mentioned above, since the image sensing apparatus 101 does not have a light metering sensor as in the first embodiment, and it is difficult to discriminate a high luminance subject image with a possibility of inversion from a high luminance subject image without a possibility of inversion, with use of output data from a light metering sensor. Further, it is difficult to make judgment, frame image after frame image, as to a possibility of inversion based on a judgment as to whether pixel data of a value smaller than a saturated value exists between pixel data of the saturated values with respect to the pixel data of the pixels arrayed in a horizontal direction in light of the processing speed performance of the image sensing apparatus 101.

In view of the above, in this embodiment, a short time exposure operation is carried out onto a pixel near the pixel for live-image generation based on an assumption that light which is analogous to the light incident onto the pixel for live-view image generation is incident onto the pixel near the pixel for live-view image generation. If the pixel near the pixel for live-view image generation is saturated even by the short time exposure operation, it is judged that the pixel for live-view image generation is also saturated, and the value of the pixel data of the pixel for live-view image generation, which is located near the pixel used for judgment of occurrence of inversion, is replaced by the saturated value, irrespective of a value of the actually acquired pixel data.

At the time of the pixel data replacement, as mentioned above, the exposure time of the pixel near the pixel for live-view image generation is set sufficiently short based on an assumption that pixel data of a sufficiently large value is obtainable from a subject image with a possibility of inversion despite the short time exposure operation. This operation is implemented to accurately judge whether light received on the respective pixels of the image sensor 116 is derived from the sunlight or from a light source other than the sun, in other words, to discriminate a high luminance subject image without a possibility of inversion from a high luminance subject image with a possibility of inversion. Hereinafter, the pixel used for judging occurrence of inversion is called as “inversion judging pixel”.

FIG. 16 shows an arrangement of pixels, wherein pixels in proximity to a pixel for live-view image generation, e.g., pixels represented by (10m-6, 10n-5), and (10m-6, 10n-4) where m and n each is a positive integer, namely, the pixels encircled by circles in FIG. 16, are set as the inversion judging pixel.

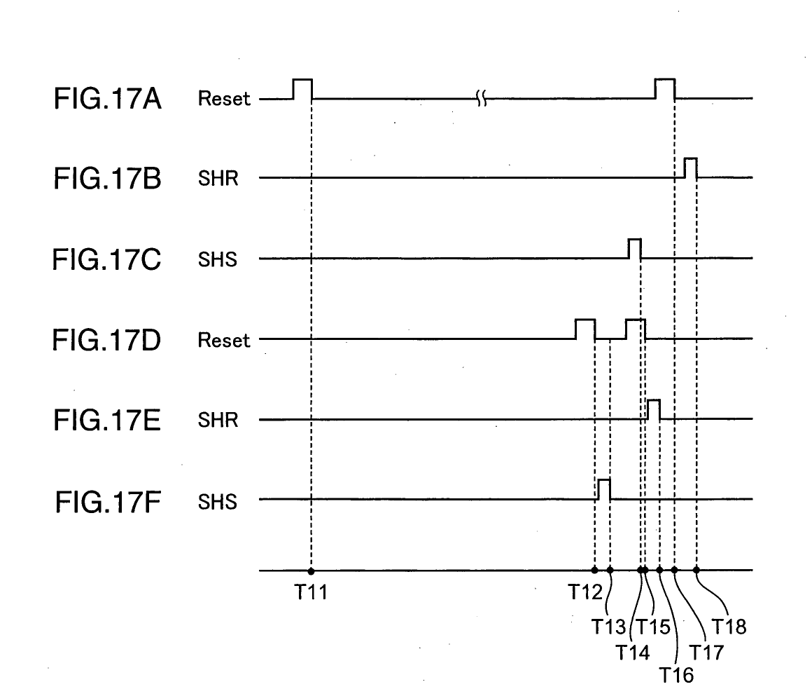

The image capture controller 124 causes the relevant parts to perform exposure operations of a pixel for live-view image generation (hereinafter, called as “live-view image generation pixel S”) shown by the arrow S in FIG. 16, and of an inversion judging pixel (hereinafter, called as “inversion judging pixel T”) shown by the arrow T in FIG. 16, and output operations of pixel signals from the respective pixels S and T in the following manner. FIGS. 17A through 17C show an exposure operation of the live-view image generation pixel S, and an output operation of a pixel signal from the live-view image generation pixel S in the case that one frame of a live-view image is generated in a process of cyclically generating a live-view image. FIGS. 17D through 17F show an exposure operation of the inversion judging pixel T, and an output operation of a pixel signal from the inversion judging pixel T, which are carried out in association with the exposure operation of the live-view image generation pixel S, and with the output operation of the pixel signal from the live-view image generation pixel S.

As shown in FIGS. 17A through 17C, the image capture controller 124 turns on a reset switch 39 (see FIG. 5) to start an exposure operation of the live-view image generation pixel S at the timing T(=T11). Then, the image capture controller 124 turns on the reset switch 39 again to terminate the exposure operation at the timing T(=T14), and then turns on the reset switch 39 again for a reset operation at the timing T(=T17). In this way, sampling operations are performed by a sampling circuit 50 at the timing T(=T14) and at the timing T(=T18) immediately after the reset operation. In this way, pixel signals constituting a live-view image is obtained.

Further, the image capture controller 124 causes the relevant parts to perform an exposure operation of the inversion judging pixel T for judging inversion during a period from the timing T(=T12) immediately before termination of the exposure operation of the live-view image generation pixel S to the timing T(=T13). Specifically, the image capture controller 124 turns on the reset switch 39, starts the exposure operation of the inversion judging pixel T at the timing T(T=12), turns on a pulse SHS, and terminates the exposure operation at the timing T(=T13).

Thereafter, the image capture controller 124 turns on the reset switch 39 again at the timing T(=T15) to perform a reset operation, turns on the pulse SHR at the timing T(=T16) to read out a reset voltage to thereby cause the sampling circuit 50 to perform a sampling operation. The period from the timing T(=T12) to the timing T(=T13) is set to, e.g., 1/10,000 sec.

In this way, a pixel signal for use in judgment on a possibility of inversion is obtained from the pixel signals constituting the live-view image.

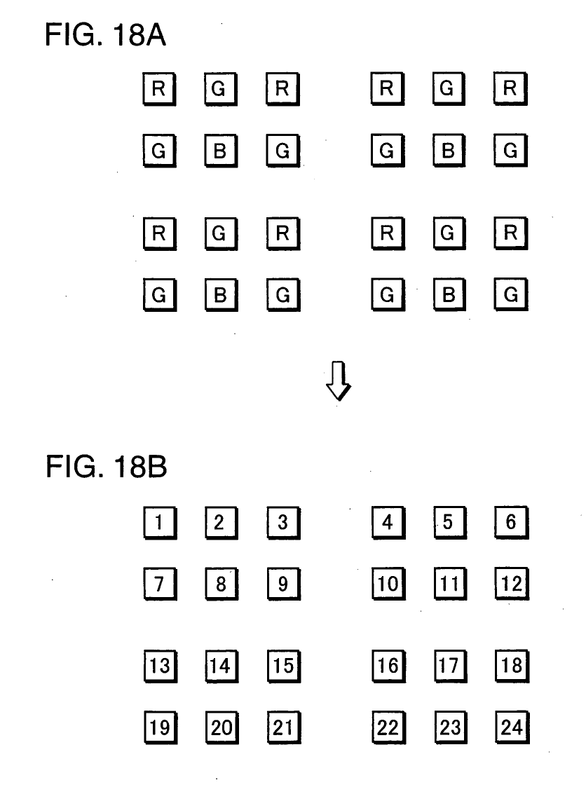

The order of outputting pixel signals from all the live-view image generation pixels, and from all the inversion judging pixels adjoining the live-view image generation pixels in the pixels of the image sensor 116 is as described below. FIG. 18A is an illustration showing all the live-view image generation pixels, and all the inversion judging pixels adjoining these live-view image generation pixels, which are extracted from the pixels of the image sensor 116 shown in FIG. 16. FIG. 18B is an illustration showing an order of outputting the pixel signals from the pixels shown in FIG. 18A.

As shown in FIG. 18B, pixel signals of all the live-image generation pixels and all the inversion judging pixels shown in FIG. 18A are outputted from the uppermost horizontal pixel row toward the lowermost horizontal pixel row, and from the leftmost pixel toward the rightmost pixel in each of the horizontal pixel rows.

The judger 126 judges whether each of the inversion judging pixels is saturated. If the judger 126 judges that there exists an inversion judging pixel in a saturated state, the judger 126 judges that the pixel data of the live-image generation pixel adjoining the detected inversion judging pixel has a possibility of inversion.

The data corrector 127 then replaces the value of the pixel data of the live-view image generation pixel by the saturated value.

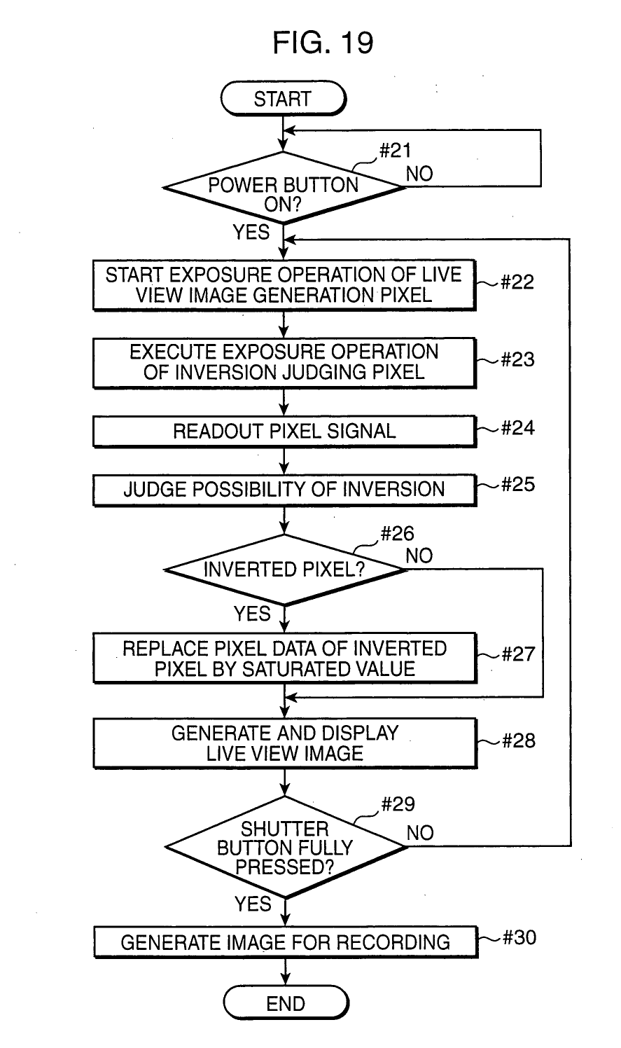

Now, the correction processing to be implemented by the image sensing apparatus 101 is described referring to a flowchart shown in FIG. 19. Referring to FIG. 19, when the main power of the image sensing apparatus 101 is turned on by the power button 109 (YES in Step #21), the main controller 123 is operated to start an exposure operation of a live-view image generation pixel for recording at a predetermined interval, e.g., every 1/30 sec (Step #22), and to execute an exposure operation of an inversion judging pixel at a predetermined interval, e.g., every 1/10,000 sec (Step #23) to read out pixel signals from the live-view image generation pixel and from the inversion judging pixel (Step #24).

Subsequently, the main controller 123 judges whether there exists a live-view image generation pixel with a possibility of inversion, namely, a possibly inverted pixel, based on the pixel signal of the inversion judging pixel in the readout pixel signals (Step #25).

If the main controller 123 judges that there exists a live-view image generation pixel with a possibility of inversion (YES in Step #26), the value of the pixel data of the live-view image generation pixel with a possibility of inversion is replaced by the saturated value (Step #27). Then, a live-view image is generated, and displayed on the LCD 107 (Step #28). On the other hand, if the main controller 123 judges that there exists no live-image generation pixel with a possibility of inversion (NO in Step #26), the main controller 123 skips Step #27, and executes Step #28.

Then, until the shutter button 104 is brought to a fully-pressed state (NO in Step #29), operations in Steps #22 through #28 are cyclically repeated. If the shutter button 104 is brought to a fully-pressed state (YES in Step #29), the main controller 123 generates an image for recording with use of the lens shutter 113 (Step #30), and terminates the processing.

By implementing the processing as mentioned above, even if the image sensing apparatus is not loaded with a light metering sensor as in the first embodiment, a live-view image with no or less inversion can be displayed on the LCD 107. A moving image captured in the moving image shooting mode can be processed in a similar manner as mentioned above, thereby eliminating or suppressing occurrence of inversion in the captured moving image.

The following modifications through may be applicable in addition to or in place of the first and second embodiments.

In the second embodiment, the pixels are divided into pixels for use in judging whether there is a possibility of inversion, and pixels for use in generating a live-view image or a moving image. Alternatively, it is possible to judge whether there is a possibility of inversion and to generate a live-view image or a moving image without dividing the pixels by implementing the following processing.

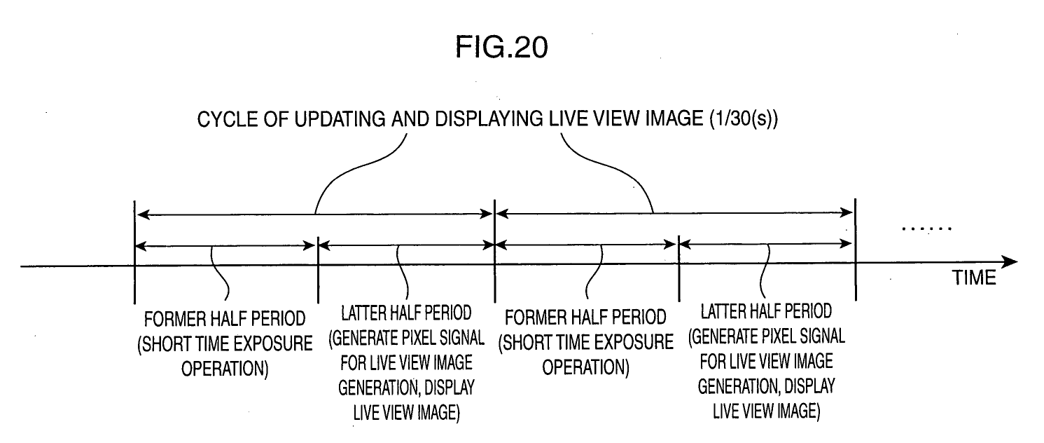

As shown in FIG. 20, the main controller 123 or the image capture controller 124 divides each cycle of updating and displaying a live-view image into two periods, namely, a former half period corresponding to a second period, and a latter half period corresponding to a first period, for instance.

In this modification, in the case where it is judged that pixel data of a live-view image generation pixel which has been obtained by a very short time exposure operation of the live-view image generation pixel in the former half period is saturated, pixel data of the live-view image generation pixel which has been obtained by an exposure operation of the live-view image generation pixel for live-view image generation in the latter half period is replaced by a saturated value, irrespective of an actually obtained output value of the pixel. This is performed based on an assumption that substantially the same light be incident onto the same pixel even if there is a very short time lag between two light incidences onto the same pixel.

Specifically, the main controller 123 reads out a pixel signal generated by an exposure operation of a live-view image generation pixel for a very short time, e.g., 1/10,000 sec in the former half period. More specifically, in the former half period, the main controller 123 discharges electric charge accumulated in the photodiode 41 (see FIG. 5) twice with a time interval of, e.g., 1/10,000 sec by turning on the reset switch 39 of the live-view image generation pixel, acquires a voltage difference between output values obtained by the two sampling operations, and generates pixel data based on the voltage difference. Thus, the main controller 123 stores the live-view image generation pixel from which the saturated value has been outputted.

Next, the main controller 123 reads out a pixel signal generated by an exposure operation of the live-view image generation pixel for a predetermined time, e.g., 1/60 sec in the latter half period. Specifically, the main controller 123 discharges electric charge accumulated in the photodiode 41 (see FIG. 5) twice with a time interval of, e.g., 1/60 sec by turning on the reset switch 39 of the live-view image generation pixel, acquires a voltage difference between output values obtained by the two sampling operations, and generates pixel data based on the voltage difference.

Then, the main controller 123 replaces the pixel data of the live-view image generation pixel having the saturated value in the former half period by the saturated value in the later half period, irrespective of the output value of the live-view image generation pixel in the latter half period, and displays a live-view image on the LCD 107.

If it is judged that an inversion has occurred in the pixel data of a live-view image generation pixel in the former half period, the possible inversion can be eliminated by implementing the above operation. In this way, an inversion in a live-view image or in a moving image can be eliminated or suppressed. In the second embodiment, as compared with the modification, a sufficient exposure time can be secured for generation of a live-view image or a moving image, which is advantageous in generating a clear live-view image or a clear moving image.

For instance, in the case that a live-view image is displayed at an interval of 1/30 sec, an exposure time for generating a live-view image is shorter than 1/30 sec, e.g., 1/60 sec in the modification, whereas an exposure time of 1/30 sec is secured for generating a live-view image in the second embodiment. Thus, generation of a clear live-view image or a clear moving image can be secured in the second embodiment.

In the modification, as mentioned above, a pixel signal is read out in the latter half period by an exposure operation of a live-view image generation pixel for a predetermined time, e.g., 1/60 sec, for instance. Alternatively, it is possible to set the pixel value of a live-view image generation pixel, which has been stored as a pixel having the saturated value in the former half period, at the saturated value without turning on the reset switch 39 or performing a sampling operation of the sampling circuit 50.

In the modification, in the case where it is judged that pixel data of a live-view image generation pixel which has been obtained by a very short exposure operation of the live-view image generation pixel in the former half period is saturated, pixel data of the live-view image generation pixel which has been obtained by an exposure operation of the live-view image generation pixel for live-view image generation in the latter half period is replaced by the saturated value, irrespective of an actually obtained output value of the pixel, based on an assumption that substantially the same light be incident onto the same pixel even if there is a very short time lag between two light incidences onto the same pixel.

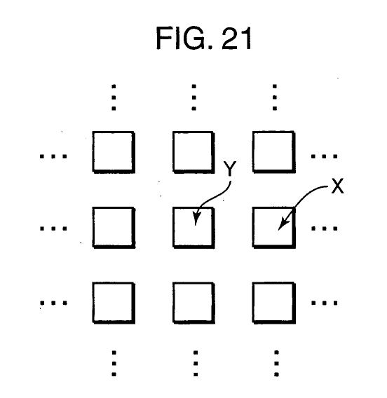

Alternatively, as shown in FIG. 21, it is possible to perform a very short time exposure operation of a pixel Y adjoining a live-view image generation pixel X in the former half period, to perform an exposure operation of the live-view image generation pixel X for a predetermined time in the latter half period for a live-view image generation, and to replace pixel data of the live-view image generation pixel X which has been obtained by the exposure operation of the live-view image generation pixel X in the latter half period by the saturated value, irrespective of an actually acquired output value of the pixel if it is judged that the pixel data of the adjacent pixel Y which has been obtained by the exposure operation of the adjacent pixel Y is saturated. This is performed based on a presumption that substantially the same light be incident onto the pixel adjacent the live-view image generation pixel even if there is a very short time lag between light incidences onto these two pixels adjacent to each other.

As a further altered form, a very short time exposure operation of the adjacent pixel Y, and an exposure operation of the live-view image generation pixel X for a predetermined time, e.g., 1/60 sec are carried out in the former half period. Further, an exposure operation of the live-view image generation pixel X for a predetermined time, e.g., 1/60 sec is carried out in the latter half period.

In the above altered arrangement, if the output value from the adjacent pixel Y is saturated in the former half period, and the output value from the live-view image generation pixel X in the former half period is smaller than the saturated value or a predetermined threshold value, it is presumed that pixel data obtained from the live-view image generation pixel X in the latter half period may have a possibility of inversion. In such a case, the pixel data outputted from the live-view image generation pixel X in the latter half period may be replaced by the saturated value, irrespective of an actually obtained output value of the pixel.

It is possible to perform the following processing for a compact camera without a lens shutter in order to eliminate or suppress occurrence of inversion in a still image to be recorded.

In such an altered arrangement, a main controller extracts an area with a possibility of inversion based on pixel data acquired by a cyclic image capturing operation by an image sensor during a photographing preparatory period until a shutter button is pressed halfway down. Then, judgment is made as to necessity of the pixel data replacement as explained in the first embodiment with respect to the extracted area. If it is judged that there is pixel data for which the pixel data replacement is necessary, the pixel data is replaced by a maximal pixel data. Alternatively, it is possible to replace pixel data for recording in the area with a possibility of inversion, which has been generated during the photographing preparatory period, by the saturated value, irrespective of an actually obtained output value of the pixel.

In the case where the compact camera as shown in the second embodiment is loaded with a light metering unit of external light passive system constructed such that light metering is performed via an optical system other than the photographic optical system, it is possible to eliminate or suppress occurrence of inversion substantially in the same manner as the first embodiment.

If an image sensing apparatus such as the compact camera has a zoom lens, the size of a light metering area is changed relative to the magnification for a subject optical image introduced by a photographic optical system. Accordingly, there is a case that the light metering area may be smaller than the image capturing area of the image sensor depending on the magnification, with the result that an area with a possibility of inversion may be displaced from the light metering area.

In order to avoid such a likelihood, it is preferable to mount a light metering unit with a light metering area at a position corresponding to an area within which a subject image with a high possibility of inversion, e.g., the sun may be primarily captured, for instance, an area corresponding to an upper area on a display screen of an LCD. Alternatively, it is possible to mount a light metering unit capable of performing light metering with respect to a primary area of the image capturing area, even in a condition that the light metering area of the light metering unit is the smallest relative to the image capturing area of the image sensor.

As described above, a novel image sensing apparatus comprises: a CMOS image sensor including a number of pixels arrayed in a first direction and a second direction orthogonal to each other; a luminance distribution detecting section which detects a luminance distribution of an optical image of a subject incidented to the image sensor; and an image processing section which corrects an output value of the pixel to a predetermined value based on a luminance distribution of a predetermined high luminance region in the luminance distribution detected by the luminance distribution detecting section.

With this arrangement, the output of the pixel is corrected to the predetermined value based on the luminance distribution of the high luminance region in the luminance distribution of the subject optical image detected by the luminance distribution detecting section. This arrangement enables to eliminate or suppress occurrence of inversion that a high luminance region is captured in black, and can prevent or suppress generation of a defected image including an image area having a high luminance in black.

The image processing section may preferably correct to the predetermined value the output value of the pixel that is equal to or smaller than a second threshold value in a region having an output value equal to or larger than a first threshold value.

The output value of the pixel in the image sensor that is equal to or smaller than the second threshold value is corrected into the predetermined value based on a judgment that the area having the output value equal to or smaller than the second threshold value exists within the area having the output value equal to or larger than the first threshold value. This arrangement enables to securely detect an area having a possibility of inversion with a simplified construction, and enables to securely eliminate or suppress occurrence of the inversion.

The first threshold value may be preferably a maximal output value operable to be outputted by the pixel. The possibly maximal output value outputted from the pixels of the image sensor, namely, a saturated value is set as the first threshold value based on an assumption that inversion highly likely occurs in the area having the saturated value. This arrangement enables to more accurately prevent occurrence of inversion, as compared with an arrangement that a value smaller than the saturated value is set as the first threshold value.

In the case where the image sensing apparatus is provided with a photographic optical system for guiding the optical image of the subject to the image sensor, preferably, the luminance distribution detecting section may include a light metering sensor having a dynamic range wider than a dynamic range of the image sensor to receive the optical image incidented by the photographic optical system for detection of a luminance of the optical image of the subject, and the image processing section may designate based on a detection signal from the light metering sensor an area of image data outputted from the image sensor that is to be used to judge whether the correction is necessary, and perform the correction judgment about an output value of a pixel of the image sensor corresponding to the designated area.

The light metering sensor is provided to receive the subject optical image incidented from the photographic optical system for detection of the subject luminance. The image processing section designates the area for judging whether the correction is necessary in the image data outputted from the image sensor with use of the detection signal from the light metering sensor, and judges whether the correction is necessary regarding the output value of the pixel in the image sensor at a position corresponding to the designated area. This arrangement enables to readily detect the area for which the correction is necessary.

Further, since the light metering sensor has the dynamic range wider than that of the image sensor, the light metering sensor is capable of outputting different output values with respect to subject images having different luminances from each other, even if the image sensor outputs the same output value with respect to the subject images. This arrangement enables to accurately discriminate a subject image without a possibility of inversion from a subject image with a possibility of inversion.

The area for which the correction is necessary can be readily detected, and the subject image without a possibility of inversion can be securely discriminated from the subject image with a possibility of inversion. This arrangement enables to precisely determine the area for which the correction is necessary.

Preferably, the image sensing apparatus may be further provided with an electronic shutter for electronically reading out a pixel signal from the pixel. The use of the electronic shutter will raise the above-mentioned advantageous effects.

The image sensing apparatus may be further provided with a first image capture controlling section which cyclically performs a first exposure operation having a first predetermined exposure time duration to a first group of pixels of the image sensor at a predetermined interval; and a second image capture controlling section which performs a second exposure operation having a second predetermined exposure time duration shorter than the first predetermined exposure time duration to a second group of pixels in the vicinity of the pixels of the first group concurrently with the first exposure operation in each cycle. In this case, the luminance distribution detecting section may preferably detect a region having an output value equal to or larger than a predetermined threshold value in output values acquired by the second exposure operation, and the image processing section may make the correction judgment about a pixel signal acquired by the first exposure operation to the first group of pixels in the region detected by the luminance distribution detecting section, and correct to the predetermined value the output value of pixels that the correction is judged to be necessary for.

The first exposure operation is carried out at the predetermined interval. Further, in each of the cycles, the second exposure operation is carried out concurrently with the first exposure operation. The luminance distribution detecting section detects the region having the output value equal to or larger than the predetermined threshold value in the output value acquired by the second exposure operation, as a region having a possibility of inversion. The image processing section judges whether the correction is necessary regarding the pixel signal acquired by the first exposure operation in the region detected by the luminance distribution detecting section, and corrects the output value of the pixel having the pixel signal for which the correction is necessary to the predetermined value. This arrangement enables to eliminate or suppress occurrence of inversion of a pixel signal acquired by an exposure operation for image display or image recording, for instance, without providing a light metering sensor.

Preferably, the image sensing apparatus may be further provided with a first image capture controlling section which cyclically performs a first exposure operation having a first predetermined exposure time duration to a first group of pixels of the image sensor at a predetermined interval; and a second image capture controlling section which performs a second exposure operation having a second predetermined exposure time duration shorter than the first predetermined exposure time duration to a second group of pixels in each cycle. In this case, preferably, the luminance distribution detecting section may detect a region having an output value equal to or larger than a predetermined threshold value in output values acquired by the second exposure operation, and the image processing section may make the correction judgment about a pixel signal acquired by the first exposure operation to the pixels of the first group in the region detected by the luminance distribution detecting section, and correct to the predetermined value the output value of the pixel that the correction is judged to be necessary for.

The first exposure operation is carried out at the predetermined interval. Further, in each of the cycles, the second exposure operation is carried out prior to the first exposure operation. The luminance distribution detecting section detects the region having the output value equal to or larger than the predetermined threshold value within the output value acquired by the second exposure operation. The image processing section judges whether the correction is necessary regarding the pixel signal acquired by the first exposure operation in the region detected by the luminance distribution detecting section, and corrects the output value of the pixel having the pixel signal for which the correction is necessary to the predetermined value. This arrangement enables to eliminate or suppress occurrence of inversion of a pixel signal acquired by an exposure operation for image display or image recording, for instance, without providing a light metering sensor. The second pixel may be identical to or different from the first pixel.

Preferably, the image sensing apparatus may be further provided with a first image capture controlling section which cyclically performs a first exposure operation having a first predetermined exposure time duration to a first group of pixels of the image sensor at a predetermined interval; a second image capture controlling section which performs a second exposure operation having a second predetermined exposure time duration to the first group of pixels before the first exposure operation in each cycle; a third image capture controlling section which performs a third exposure operation having a third predetermined exposure time duration shorter than the second predetermined exposure time duration to a second group of pixels in the vicinity of the pixels of the first group concurrently with the second exposure operation in each cycle. In this case, preferably, the luminance distribution detecting section may detect a capture difference between an output value acquired by the second exposure operation and an output value acquired by the third exposure operation, and the image processing section may correct to the predetermined value the output value acquired by the first exposure operation immediately after the second exposure operation which causes a capture difference exceeding a reference value.

The first exposure operation is carried out in the first period at the predetermined interval. Further, in each of the cycles, the second exposure operation is carried out in the second period preceding the first period. Further, the third exposure operation is carried out concurrently with the second exposure operation. The luminance distribution detecting section detects the capture difference in output values acquired by the second exposure operation and the second exposure operation. The image processing section corrects the output value acquired by the first exposure operation immediately after the second exposure operation to the predetermined value if it is judged that the output value difference is over the reference value. The above arrangement enable to eliminate or suppress occurrence of inversion of a pixel signal acquired by an exposure operation for image display or image recording, for instance, without providing a light metering sensor.

Preferably, the image sensing apparatus may be further provided with an electronic shutter for electronically controlling the exposure to the image sensor, and a mechanical shutter for mechanically controlling the exposure to the image sensor, wherein the image processing section executes the correction when the pixel signal is acquired by the electronic shutter.

Preferably, the image sensing apparatus may be further provided with an image display section which displays an image; and a display controlling section which updates and displays the image on the image display section, the image being constituted of the pixel signal acquired by the first exposure operation.

Preferably, the image sensing apparatus may be further provided with a storage which stores the pixel signal acquired by the first exposure operation.

In the case where the image sensing apparatus has the electronic shutter mode of capturing the subject image by reading out pixel signals acquired by the exposure operation of pixels at the predetermined interval, and the mechanical shutter mode of capturing the subject image with use of the mechanical shutter, the correction of the output value is executed when the image sensing apparatus is in the electronic shutter mode. Accordingly, the inversion in an image acquired by the cyclic exposure operation by the image sensor can be eliminated or suppressed.

Preferably, the predetermined value may be a maximal output value of the pixel. Since the output value of the pixel is corrected by the possible maximal output value outputted from the pixels, an region which is supposed to have a high luminance can be securely captured as the region having the high luminance such as a maximal luminance, thereby enabling to secure high image reproducibility with respect to the subject image.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image sensing apparatus comprising:
a CMOS image sensor including a number of pixels arrayed in a first direction and a second direction orthogonal to each other;
a luminance distribution detecting section which detects a luminance distribution of an optical image of a subject incidented to the image sensor; and
an image processing section which corrects an output value of the pixel to a predetermined value based on a luminance distribution of a predetermined high luminance region in the luminance distribution detected by the luminance distribution detecting section.

2. The image sensing apparatus according to claim 1, wherein
the image processing section corrects to the predetermined value the output value of the pixel that is equal to or smaller than a second threshold value in a region having an output value equal to or larger than a first threshold value.

3. The image sensing apparatus according to claim 2, wherein the first threshold value is a maximal output value operable to be outputted by the pixel.

4. The image sensing apparatus according to claim 1, further comprising a photographic optical system which guides the optical image of the subject to the image sensor, wherein
the luminance distribution detecting section includes a light metering sensor having a dynamic range wider than a dynamic range of the image sensor to receive the optical image incidented by the photographic optical system for detection of a luminance of the optical image of the subject, and
the image processing section designates based on a detection signal from the light metering sensor an area of image data outputted from the image sensor that is to be used to judge whether the correction is necessary, and performs the correction judgment about an output value of a pixel of the image sensor corresponding to the designated area.

5. The image sensing apparatus according to claim 1, further comprising an electronic shutter for electronically reading out a pixel signal from the pixel.

6. The image sensing apparatus according to claim 1, further comprising:
a first image capture controlling section which cyclically performs a first exposure operation having a first predetermined exposure time duration to a first group of pixels of the image sensor at a predetermined interval; and
a second image capture controlling section which performs a second exposure operation having a second predetermined exposure time duration shorter than the first predetermined exposure time duration to a second group of pixels in the vicinity of the pixels of the first group concurrently with the first exposure operation in each cycle, wherein
the luminance distribution detecting section detects a region having an output value equal to or larger than a predetermined threshold value in output values acquired by the second exposure operation, and
the image processing section makes the correction judgment about a pixel signal acquired by the first exposure operation to the first group of pixels in the region detected by the luminance distribution detecting section, and corrects to the predetermined value the output value of pixels that the correction is judged to be necessary for.

7. The image sensing apparatus according to claim 6, further comprising an electronic shutter for electronically controlling the exposure to the image sensor, and a mechanical shutter for mechanically controlling the exposure to the image sensor, wherein the image processing section executes the correction when the pixel signal is acquired by the electronic shutter.

8. The image sensing apparatus according to claim 6, further comprising:
an image display section which displays an image; and
a display controlling section which updates and displays the image on the image display section, the image being constituted of the pixel signal acquired by the first exposure operation.

9. The image sensing apparatus according to claim 6, further comprising a storage which stores the pixel signal acquired by the first exposure operation.

10. The image sensing apparatus according to claim 1, further comprising:
a first image capture controlling section which cyclically performs a first exposure operation having a first predetermined exposure time duration to a first group of pixels of the image sensor at a predetermined interval; and
a second image capture controlling section which performs a second exposure operation having a second predetermined exposure time duration shorter than the first predetermined exposure time duration to a second group of pixels in each cycle, wherein
the luminance distribution detecting section detects a region having an output value equal to or larger than a predetermined threshold value in output values acquired by the second exposure operation, and
the image processing section makes the correction judgment about a pixel signal acquired by the first exposure operation to the pixels of the first group in the region detected by the luminance distribution detecting section, and corrects to the predetermined value the output value of the pixel that the correction is judged to be necessary for.

11. The image sensing apparatus according to claim 10, further comprising an electronic shutter for electronically controlling the exposure to the image sensor, and a mechanical shutter for mechanically controlling the exposure to the image sensor, wherein the image processing section executes the correction when the pixel signal is acquired by the electronic shutter.

12. The image sensing apparatus according to claim 10, further comprising:
an image display section which displays an image; and
a display controlling section which updates and displays the image on the image display section, the image being constituted of the pixel signal acquired by the first exposure operation.

13. The image sensing apparatus according to claim 10, further comprising a storage which stores the pixel signal acquired by the first exposure operation.

14. The image sensing apparatus according to claim 1, further comprising:
a first image capture controlling section which cyclically performs a first exposure operation having a first predetermined exposure time duration to a first group of pixels of the image sensor at a predetermined interval;
a second image capture controlling section which performs a second exposure operation having a second predetermined exposure time duration to the first group of pixels before the first exposure operation in each cycle;
a third image capture controlling section which performs a third exposure operation having a third predetermined exposure time duration shorter than the second predetermined exposure time duration to a second group of pixels in the vicinity of the pixels of the first group concurrently with the second exposure operation in each cycle, wherein
the luminance distribution detecting section detects a capture difference between an output value acquired by the second exposure operation and an output value acquired by the third exposure operation, and
the image processing section corrects to the predetermined value the output value acquired by the first exposure operation immediately after the second exposure operation which causes a capture difference exceeding a reference value.

15. The image sensing apparatus according to claim 14, further comprising an electronic shutter for electronically controlling the exposure to the image sensor, and a mechanical shutter for mechanically controlling the exposure to the image sensor, wherein the image processing section executes the correction when the pixel signal is acquired by the electronic shutter.

16. The image sensing apparatus according to claim 14, further comprising:
an image display section which displays an image; and
a display controlling section which updates and displays the image on the image display section, the image being constituted of the pixel signal acquired by the first exposure operation.

17. The image sensing apparatus according to claim 14, further comprising a storage which stores the pixel signal acquired by the first exposure operation.

18. The image sensing apparatus according to claim 1, wherein the predetermined value is a maximal output value of the pixel.
